(19) United States
(12) Patent Application Publication
(10) Pub. No.: US 2025/0313281 A1
(43) Pub. Date: Oct. 9, 2025

(54) VEHICLE

(71) Applicant: Ocado Innovation Limited, Hatfield (GB)

(72) Inventors: David SHARP, Hatfield (GB); Joseph ZAMMIT, Hatfield (GB); Sean CLARK, Hatfield (GB); Benjamin THOMAS, Hatfield (GB); Clementine BIET, Hatfield (GB); Daniel VARGA, Hatfield (GB); Patrick GONDA, Hatfield (GB); Kris TURNER, Hatfield (GB); Matt HICKEY, Hatfield (GB); Sergey ZHELYABOVSKIY, Hatfield (GB)

(21) Appl. No.: 19/242,709

(22) Filed: Jun. 18, 2025

Related U.S. Application Data
(63) Continuation of application No. PCT/EP2023/086975, filed on Dec. 20, 2023.

(30) Foreign Application Priority Data
Dec. 21, 2022 (GB) 2219397.3
Oct. 2, 2023 (GB) 2315088.1

(51) Int. Cl. B62D 33/04; B60J 5/04

(52) U.S. Cl. CPC B62D 33/042; B60J 5/0473

(57) ABSTRACT

A vehicle including: a first row of one or more first-type storage devices, each first-type storage device including a first carrier configured to be moved outwards from a first stowed position to a first deployed position substantially outside the footprint of the vehicle; a second row of one or more second-type storage devices located vertically above the first row of first-type storage devices, wherein each of the one or more second-type storage devices comprises a second carrier configured to be moved outwards from a second stowed position to a second deployed position substantially outside the footprint of the vehicle; wherein the spatial volume occupied by one of the second carriers when in the second deployed position occupies at least a portion of the spatial volume occupied by one of the first carriers when in the first deployed position.

### RELATED APPLICATIONS

This application is a continuation of International Patent Application No. PCT/EP2023/086975 filed 20 Dec. 2023 and entitled “Vehicle”, which claims priority to (i) GB Application No. 2219397.3 filed 21 Dec. 2022 and entitled “Vehicle”, and (ii) GB Application No. 2315088.1 filed 2 Oct. 2023 and entitled “Vehicle”; the entire contents of all of which applications are incorporated herein by reference.

### TECHNICAL FIELD

The disclosure relates to a vehicle, more particularly to a vehicle comprising a plurality of storage devices, e.g. for use as a delivery vehicle.

### BACKGROUND

In a traditional brick and mortar store based commerce, goods are typically distributed in a sequence from the manufacturer, to the wholesaler, to the retailer, and finally to the customer. Retail shops function as the end points of the distribution chain. The customers mostly have to take care of the ‘last mile’ transportation of goods, i.e. delivery from the physical point of purchase to home; the end of the distribution chain may be extended to the consumers' households.

However, customers taking care of “last mile” delivery is largely not the case with e-commerce, where products purchased online are transported from a distribution center to either a collection point accessible by a customer or directly to a customer's home in a timely manner. As a result, the development of online shopping has led to a plethora of different e-commerce models for the purchase of goods online. These range from the click and collect model where customers purchasing or selecting goods online can either pick the goods up in a store of choice or at a centralized collection location, or a home delivery service where goods are delivered directly to the customer's premises.

Click and collect models are a secure access system for the delivery of goods ordered by a customer online to an automated collection point, which is accessible by a customer. The automated collection point typically has the form of a bank of electronically operated lockers controllable by a locker management system to control the allocation and access to one or more of the plurality of lockers upon receipt of an order of goods. Access to the lockers may be provided by communicating a collection code to a customer's device upon receipt of an order of goods such that when the collection code unique to the order is entered into a local user interface coupled to the bank of electronically operated lockers, access to the goods stored in one or more of the lockers allocated to the customer is permitted.

A home delivery service can be provided by a vehicle with a driver. After receiving an order from a customer, the customer's order is packed at a warehouse or distribution center, and loaded onto a vehicle. The vehicle is driven to a customer's home or other collection address, and then the driver takes the order to the customer's door. Home delivery services can be provided by the retailers or suppliers of the goods, or alternatively home delivery services can be provided by a third party.

In cases where the driver of the vehicle retrieves the goods from the vehicle to carry to the customer's door, it is advantageous to have the goods presented at a convenient height and angle, given that the driver is likely to spend a lot of time over a working day repeatedly retrieving and carrying goods for different customers. A vehicle that presents the goods in a convenient manner will save time, thus facilitating faster deliveries, as well as being more comfortable and safer for the driver.

Another option is autonomous delivery. After receiving an order from a customer, the customer's order is packed at a warehouse or distribution center, and loaded onto an autonomous vehicle. The autonomous vehicle is provided with one or more compartments to store customers' orders. The autonomous vehicle drives to the customer's home or other delivery address where the customer can retrieve their order from the vehicle.

With autonomous delivery, since there is no driver to retrieve the goods from the vehicle and bring them to the customer's doorstep, customers need to retrieve their own goods from the vehicle. This can be difficult, particularly with large orders, for example grocery orders. The shopping bags may be heavy and inconvenient to lift out of the vehicle. The customers are members of the general public, so the orders must be able to be retrieved by anyone, including people of different height and physical strength, and also including elderly or disabled people.

In addition, the vehicle needs to provide access to the customer's own order but prevent access to other orders in the same vehicle.

A means of enabling users to quickly and easily retrieve goods from a vehicle is advantageous.

### SUMMARY

The disclosure is a vehicle comprising:
a first row of one or more first-type storage devices, each first-type storage device comprising a first carrier configured to be moved outwards from a first stowed position to a first deployed position substantially outside the footprint of the vehicle;
a second row of one or more second-type storage devices located vertically above the first row of first-type storage devices, wherein each of the one or more second-type storage devices comprises a second carrier configured to be moved outwards from a second stowed position to a second deployed position substantially outside the footprint of the vehicle;
wherein the spatial volume occupied by one of the second carriers when in the second deployed position occupies at least a portion of the spatial volume occupied by one of the first carriers when in the first deployed position.

An advantage of this arrangement is the combination of high storage density of goods in the vehicle and convenience retrieving goods. Using overlapping spatial volume for the first carrier and the second carrier allows the first and second carrier to be presented at a convenient height to facilitate retrieval of their goods. This is particularly important for large orders (e.g. grocery orders) comprising multiple bags or heavy bags or heavy items. If the goods are presented at a height that is too low, lifting up the bags or the heavy items may be difficult. Similarly, if the goods are presented at a height that is too high, again retrieving the goods may be difficult because the goods need to be lifted up out of the carrier and then lowered down. Visibility of the goods may be inadequate, and good visibility is needed to pick up the goods or grasp the handles of the bags containing the goods.

Presenting goods in a carrier which is in a deployed position outside the footprint of the vehicle is advantageous in that the goods can be presented at a different height and/or a different angle to the height and/or angle of the carrier when in the stowed position. The deployed position can be chosen to be a convenient height and/or angle for the retrieval of the goods, without affecting the efficiency of packing of goods in the vehicle.

In some examples, the vehicle may comprise further rows of storage devices, for example a third row of storage devices. Any number of rows of storage devices can be provided, depending on the vehicle size. Any number of storage devices can be provided in each row.

One or more of the first carriers may be configured to move from the first stowed position to the first deployed position by sliding in a substantially horizontal direction and tilting such that the first carrier is rotated relative to the horizontal in the first deployed position.

Sliding horizontally moves the first carrier out from the first stowed position within the vehicle footprint to outside the vehicle footprint, where the carrier can be accessed. The first carrier in the deployed position can be tilted either upwards (e.g. away from a customer or user) or downwards (e.g. towards a customer or user). Tilting downwards presents the goods within the first carrier at a convenient angle, so that the goods can be more easily retrieved. In addition, the first carrier being tilted downwards has the advantage that the contents of the first carrier can be seen more easily, both in order to retrieve the goods and in order to check that the correct goods have been presented. Tilting upwards can be advantageous in cases where the first carrier is accessed from a front face, i.e. the first carrier is tilted upwards so that the base of the first carrier (which is horizontal in the stowed position) is tilted upwards (e.g. away from a customer or user), and the front face is tilted backwards (e.g. away from the user or customer), so that goods or items within the carrier can more easily be accessed.

The first carrier may further comprise a runner configured to be supported by two or more bearings as the traveller moves along the substantially horizontal portion of the guide in a substantially horizontal direction. The advantage of a runner (separate from the guide) is that the runner can bear a large proportion of the weight of the first carrier. The guide therefore does not need to be strong enough to bear the entire weight of the first carrier and any goods contained within the first carrier, so can be constructed from lighter and cheaper materials. The runner may be a simple straight flange at the base of the first carrier. The use of two or more bearings ensures that the first carrier remains level as the first carrier moves in a substantially horizontal direction, guided by the substantially horizontal portion of the guide.

An outer shell may limit rotation of the first carrier relative to the outer shell when the first carrier is in the first stowed position, and may permit rotation of the first carrier relative to the outer shell when the first carrier is in the first deployed position. An advantage of the outer shell limiting rotation of the first carrier is that when the first carrier moves from the first stowed position to the first deployed position, the first carrier cannot “overshoot” the first position and risk the first carrier being removed entirely from the vehicle. The outer shell performing the function of limiting rotation of the first carrier means that there is no need for another part or another mechanism (for example, a stop) for this purpose, thus advantageously reducing the part count, cost, and complexity of the first-type storage device.

The first carrier may comprise a front face that can be moved in order to provide access to the inside of the first carrier to facilitate loading and unloading. This feature is particularly advantageous in cases where goods or items are packed into storage containers (for example, standard size storage containers used in a warehouse or storage and retrieval system), because a storage container can be directly loaded into or unloaded from a first carrier in the vehicle without the need to repack the goods or items into the first carrier.

The first-type storage device may further comprise a chain connected at a first end to the first carrier, such that pulling the chain at a second end moves the first carrier from the first deployed position to the first stowed position. This enables the first carrier to be retracted from the first deployed position to the first stowed position, without the need to manually push the first carrier back to the first stowed position. Manually pushing the first carrier back into the first stowed position requires a degree of physical strength, as well as being inconvenient while carrying goods or shopping bags.

The chain may be constrained via a chain guide, such that the chain is sufficiently rigid so that pushing the chain at the second end moves the first carrier from the first stowed position to the first deployed position. The chain guide permits the chain to be pushed as well as pulled, so that the same chain can be used both to move the first carrier from the deployed position to the stowed position, and to move the first carrier from the stowed position to the deployed position. It is advantageous to remove the need to manually pull the first carrier out to the first deployed position. Not only would manually pulling the first carrier out into the first deployed position require physical strength, but also manually pulling out the first carrier makes it more difficult to identify which of the first-type storage devices is the one that holds the required order.

The guide may comprise the chain guide. This is particularly advantageous in examples where the first-type storage device comprises a guide-and-traveler arrangement as discussed above, since the chain can be directed through the guide rather than the first-type storage device needing to be provided with a separate chain guide, thus advantageously reducing the part count, weight, and complexity of the first-type storage mechanism.

At least one of the second carriers may be configured to move from the second stowed position to the second deployed position, wherein the second deployed position is at a lower vertical level than the deployed position. Advantageously, this arrangement allows more efficient use of space within the vehicle, since goods and items can be transported at a high vertical level, thus using all available space in the vehicle, while still presenting the second carrier at a convenient height for retrieval of goods/items from the second carrier.

The second carrier may be further configured to tilt such that the second carrier is rotated relative to the horizontal in the second deployed position. The second carrier in the second deployed position can be tilted either upwards (e.g. away from a customer or user) or downwards (e.g. towards the customer or user). As described above, the second carrier tilting downwards presents the goods within the second carrier at a convenient angle for easy retrieval of the goods. In addition, the second carrier being tilted downwards has the advantage that the contents of the second carrier can more easily be seen, both in order to retrieve the goods and in order to check that the correct goods have been presented. Tilting upwards can be advantageous in cases where the second carrier is accessed from a front face, i.e. the second carrier is tilted upwards so that the base of the second carrier (which is horizontal when in the second stowed position) is tilted upwards (e.g. away from a customer or user), and the front face is tilted backwards (e.g. away from the user or customer), so that goods or items within the second carrier can more easily be accessed.

The second-type storage device may comprise:
a first linkage, pivotably connected at a first end to a first fixed point on the vehicle and pivotally connected at a second end to the second carrier;
a second linkage, pivotably connected at a first end to a second fixed point on the vehicle and pivotally connected at a second end to the second carrier;
such that the second carrier is configured to follow a curved path from the second stowed position to the second deployed position.

The second linkage may be shaped such that the first and second linkages are able to pivot below the horizontal to lower the second carrier to the second deployed position without the first linkage obstructing the second linkage.

The first linkage may be shaped such that, when the second carrier is in the second deployed position, the second linkage rests on the first linkage at two contact points between the first linkage and the second linkage. Advantageously, two contact points provides a more stable configuration of the first and second linkages when in the second deployed position.

The first fixed point may be at a lower vertical level than the second fixed point, such that the first linkage is prevented from obstructing the second linkage in order to permit the first and second linkages to lower the second carrier to the second deployed position. Vertically offsetting the first and second fixed points is an alternative way of permitting the first and second linkages to rotate below the horizontal, and does not require the first linkage or the second linkage to be curved or angled, i.e. the first and second linkages can be straight elongate members and still be able to rotate below the horizontal. Advantageously, straight elongate members are easier and less expensive to manufacture than curved, angled, or otherwise shaped linkages. In general, the length, shape, and positions of the first and second linkages can be varied in order to define the path that the second carrier takes between the second stowed position and the second deployed position.

The vehicle may be an autonomous vehicle. Autonomous vehicles have the advantage of saving on labour costs in that no driver is required to drive the vehicle, while still providing home deliveries. The autonomous vehicle may comprise one or more sensors (e.g. cameras, radar, lidar, sonar, GPS, etc.) and a control system configured to receive input from the one or more sensors to allow the vehicle to drive between destinations without input, or with minimal input, from a human driver. The control system may be configured to control one or more of: speed, steering, and braking of the vehicle.

### BRIEF DESCRIPTION OF THE FIGURES

The disclosure will be described by way of example only by reference to the following figures.

FIG. 1 schematically illustrates a vehicle with two rows of storage devices.

FIG. 2 schematically illustrates the vehicle of FIG. 1, with one of the first-type storage devices in a first deployed position.

FIG. 3 schematically illustrates the vehicle of FIG. 1, with one of the second-type storage devices in a second deployed position.

FIG. 4 (a to c) schematically illustrates an embodiment of a tilting carrier mechanism in (a) a stowed position (b) an intermediate position (c) a deployed position.

FIG. 5 (a to c) is a side view of the tilting carrier mechanism of FIG. 4 in (a) a stowed position (b) an intermediate position (c) a deployed position.

FIG. 6 illustrates the principle of constraining a chain with a guide.

FIG. 7 schematically illustrates an embodiment of a tilting carrier mechanism with a linkage arm to allow the carrier to move further from the stowed position.

FIG. 8 schematically illustrates the tilting carrier mechanism of FIG. 4 with the front face lifted up.

FIG. 9 (a to d) schematically illustrates an embodiment of a tilting carrier mechanism in (a) a stowed position (b) an intermediate position (c) a deployed position (d) a deployed and tilted position.

FIG. 10 schematically illustrates an embodiment of a drop-down carrier mechanism.

FIG. 11 (a to f) schematically illustrates an embodiment of a drop-down carrier mechanism in various positions.

FIG. 12 schematically illustrates an embodiment of a drop-down carrier mechanism.

FIG. 13 (a to d) schematically illustrates an embodiment of a drop-down carrier mechanism in various positions.

FIG. 14 (a to c) is a schematic side view of a vehicle with different arrangements of first-type and second-type storage devices.

FIG. 15 (a and b) is a schematic side view of a vehicle with different arrangements of first-type, second-type, and third-type storage devices.

FIG. 16 (a and b) is a side view of the tilting carrier mechanism of FIG. 9 showing a chain guide in (a) the stowed position, and (b) the deployed position.

FIG. 17 is a schematic view of the tilting carrier mechanism of FIG. 16 with some parts removed for ease of visualization.

FIG. 18 schematically illustrates a unit comprising two tilting carrier mechanisms.

FIG. 19 schematically illustrates a side view of the unit of FIG. 18 with both carriers in the deployed position.

FIG. 20 schematically illustrates a piece of the tilting drawer mechanism of FIG. 18, in (a) side view from the inside of the outer shell (b) side view from the outside of the outer shell, and (c) perspective view.

FIG. 21 schematically illustrates (a) a drawer or carrier with insulated side walls, and a lid, eutectic plate, and plate holder in (b) exploded view, and (c) assembled view.

### DETAILED DESCRIPTION

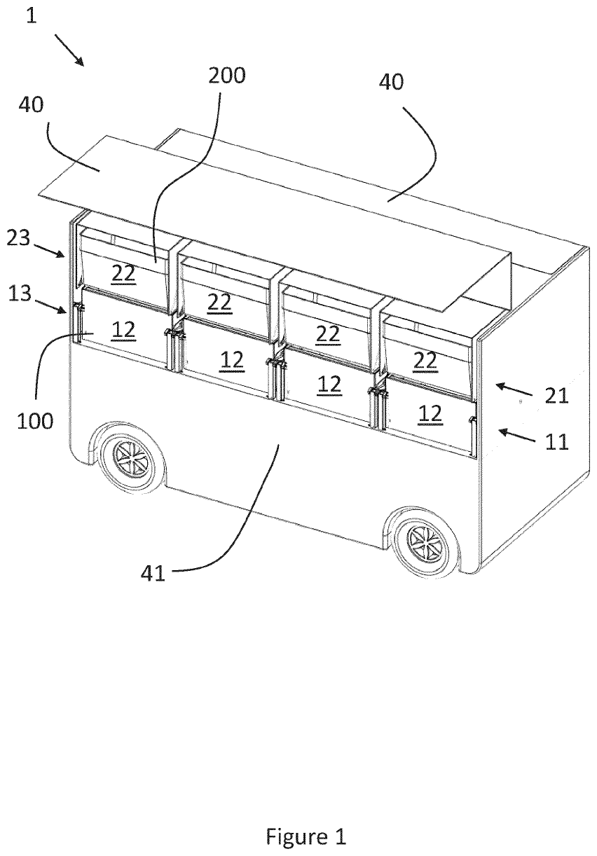

FIG. 1 schematically illustrates a vehicle 1 with two rows of storage devices. The first row 11 (the lower row in the illustrated figure) comprises first-type storage devices 12, each first-type storage device 12 comprising a first carrier 100. The first carriers 100 are in a first stowed position 13, i.e. a closed position, where the first carrier 100 of the first-type storage device is substantially within the vehicle 1. When the first carrier of the first-type storage device is in the first stowed position, any goods or items inside the first carrier 100 are not accessible from outside the vehicle.

The second row 21 (the upper row in the illustrated figure) comprises second-type storage devices 22. The second row 21 is located vertically above the first row 11. The second-type storage devices 22 each comprise a second carrier 200 in a second stowed position 23, i.e. a closed position, where the second carriers of the second-type storage devices are substantially within the vehicle 1. When the second carrier 200 of the second-type storage device 22 is in the second stowed position, any goods or items inside the second carrier 200 are not accessible from outside the vehicle.

In the illustrated example there are four first-type storage devices 12 in the first row 11, and four second-type storage devices 22 in the second row 21, positioned directly above the first row 11 so that each second-type storage device 22 is positioned directly above a respective first-type storage device 12. In other examples, as will be described later, different numbers or arrangements of first-type 12 and second-type 22 storage devices are possible.

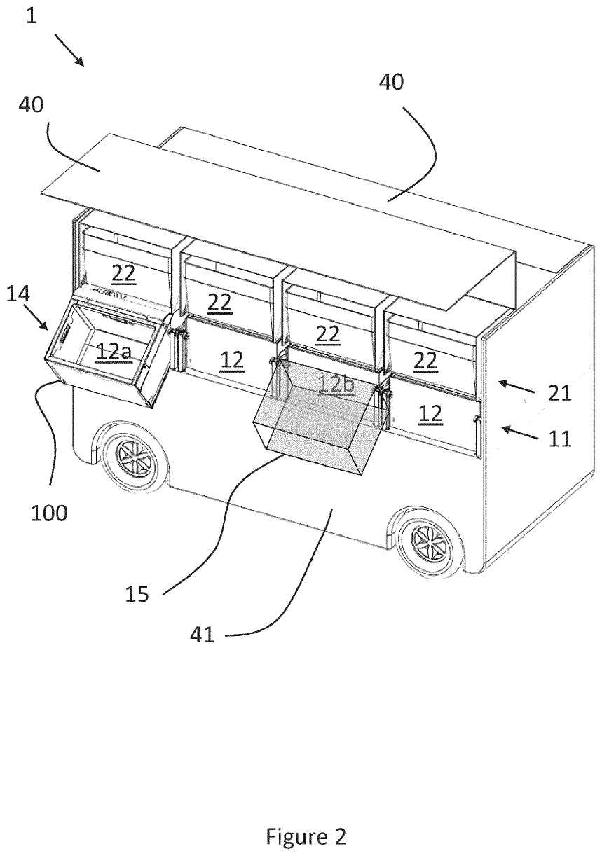

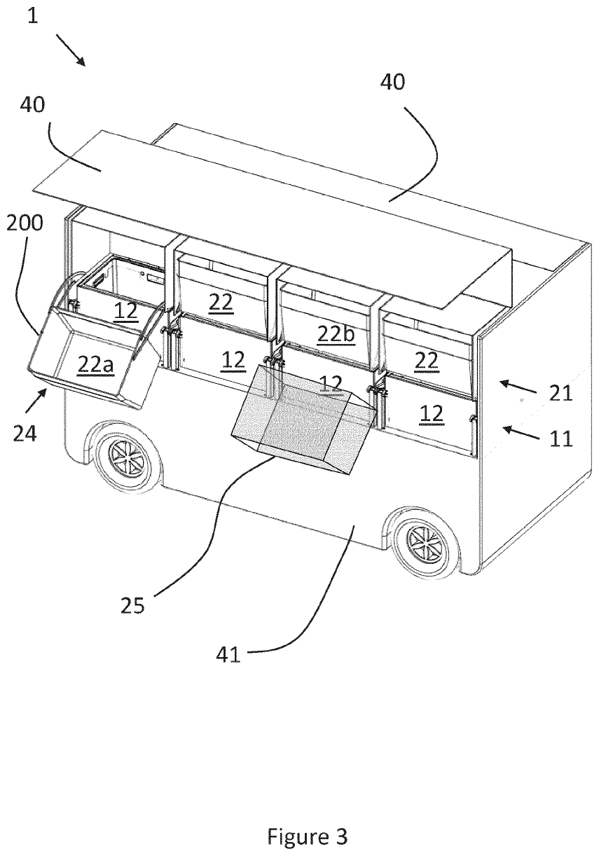

The vehicle 1 as illustrated in FIG. 1 comprises a pair of vehicle doors 40 on opposing sides of the vehicle 1. The vehicle door 40 on the near side of the vehicle 1 is in an open position, in order to allow the first-type 12 and second-type 21 storage devices to be deployed, as will be described later. The vehicle door 40 on the far side of the vehicle 1 is in a closed position, preventing access to storage devices 12, 22 on the far side of the vehicle 1. The vehicle doors 40 in this example are wing doors that open upwards and outwards, which has the advantage of not obstructing movement of the storage devices and not extending far beyond the footprint of the vehicle 1, which is an advantage in confined spaces. In other examples, different types or configurations of vehicle doors 40 can be used. FIG. 2 schematically illustrates the vehicle 1 of FIG. 1, where one of the first-type storage devices (labelled 12a in FIG. 2) has its first carrier 100 in a first deployed position 14, i.e. in an open position.

In the first deployed position 14, the first carrier 100 of the first-type storage device 12a is substantially outside the footprint of the vehicle 1, and any goods or items inside the first-type storage device are accessible from outside the vehicle. The first carrier 100 of the first-type storage device 12 occupies a spatial volume 15 when in the first deployed position 14. For clarity, the spatial volume 15 is illustrated on FIG. 2 for the first carrier of another first-type storage device 12b which is in the stowed position 13. In the illustrated example, the first-type storage device 12 is a tilting drawer mechanism, with a first carrier 100 that slides out horizontally and tilts downwards in order to present the goods inside the first carrier 100 at a convenient angle for retrieval. In other examples, the first-type storage device 12 may be a different kind of storage device.

FIG. 3 schematically illustrates the vehicle 1 of FIG. 1, where one of the second-type storage devices 22 has its second carrier 200 in a second deployed position 24, i.e. in an open position. In the second deployed position 24, the second carrier 200 of the second-type storage device 22a is substantially outside the footprint of the vehicle 1, and any goods or items inside the second carrier of the second-type storage device are accessible from outside the vehicle. The second carrier 200 of the second-type storage device 22 occupies a spatial volume 25 when in the second deployed position 25. For clarity, the spatial volume 25 is illustrated for the second carrier of another second-type storage device 22b which is in the second stowed position 23. In the illustrated example, the second-type storage device 22 is a drop-down drawer mechanism where the carrier 200 extends outwards and downwards, and tilts downwards in order to present the goods at a convenient height and at a convenient angle for retrieval. In other examples, the second-type storage device 22 may be a different kind of storage device.

The first-type storage device 12 and the second-type storage device 22 as illustrated in FIGS. 2 and 3 are different kinds of storage device, but in other examples the first-type storage device 12 and the second-type storage device 22 may be the same kind of storage device.

It can be seen from FIGS. 2 and 3 that the spatial volume 15 occupied by the first carrier of a first-type storage device 12 when in the first deployed position 14 overlaps with the spatial volume 25 occupied by the second carrier of a second-type storage device 22 when in the second deployed position 24. The reason for this is to allow retrieval of an order from a storage device at a convenient height for lifting bags out of the carrier. If there were no overlap between the spatial volumes 15 and 25, the second carrier 200 second-type storage device 22 in the second deployed position 23 would be too high, and not convenient for retrieval of goods, particularly if the order contains heavy bags full of groceries. Also the lower height of the second deployed position 23 permits visibility of the second carrier 200 of the second-type storage device 22, i.e. the contents of the second carrier 200 can easily be seen. Being able to see the contents of the first and second carriers 100, 200 is useful for verification that the correct order is present, and enables the order to be more easily retrieved, e.g. by picking up items or by grasping the handles of grocery bags in order to lift the bags out of the carrier.

In some examples, one or more of the first carriers of the first-type storage devices and/or the second carriers of the second-type storage devices may comprise a storage container. FIG. 2 illustrates a storage container within the first carrier 100 of the first-type storage device 12a. Storage containers may be more convenient for loading the vehicle with orders for delivery, especially in cases where the vehicle is loaded or unloaded at a warehouse or fulfillment center where standard storage containers are used as part of the storage, retrieval, and picking processes. Orders that are packed at a warehouse into the storage container can then be quickly and easily loaded into or unloaded from the carriers of the storage devices of the vehicle, without the need to unpack and repack.

As can be seen from FIG. 2, the first carrier 100 of the first-type storage device 12a is sized appropriately to hold one storage container. In some examples, each first carrier of each first-type storage device 12 and each second carrier 200 or each second-type storage device 22 holds a storage container. In other examples, some of the first carriers 100 and the second carrier 200 may hold storage containers, and other first carriers 100 and second carriers 200 may have items placed directly in them, and/or some first carriers 100 and second carriers 200 may contain more than one storage container.

Although in the example illustrated in FIGS. 1 to 3, the first and second carriers 100, 200 and the storage containers located therein are oriented with the long side parallel to the side of the vehicle 1, in other examples the first and second carriers 100, 200 and the storage containers located therein can be presented in a different orientation, i.e. with the short side parallel to the side of the vehicle 1.

The latter arrangement may be advantageous in that the long sides of the first and second carriers 100, 200 and the storage containers located therein on opposing sides of the vehicle extend across the width of the vehicle. The carriers and storage containers occupy more of the space within the vehicle, thus leading to a higher storage density and more effective use of space within the vehicle.

In some examples, multiple storage containers can be used in the same first or second carrier. In other examples, goods or items can be loaded directly into the first and second carriers without the use of storage containers.

Storage containers can be used to store items in grid-based storage and retrieval systems. The use of storage containers in the vehicle 1 has the advantage that storage containers containing orders from a grid-based storage and retrieval system can be placed directly into the vehicle, from which orders can be retrieved, without the need to manually transfer or decant or pack/unpack the items out of the storage containers. This improves the system efficiency, and results in faster order fulfilment and lower costs.

### Tilting Drawer Mechanism—First Embodiment

In the illustrated example of FIG. 2, the first-type storage device 12 is a tilting drawer mechanism where the carrier 100 is configured to slide outwards in a substantially horizontal direction relative to the vehicle 1, and then tilt. The tilting drawer mechanism 12 comprises a carrier 100 which slides continuously between the first stowed position 13, in which the carrier 100 is fully within the vehicle, to the first deployed position 14, in which the carrier 100 is substantially outside the vehicle footprint, and also tilted downwards. In other examples, the carrier 100 can be tilted upwards.

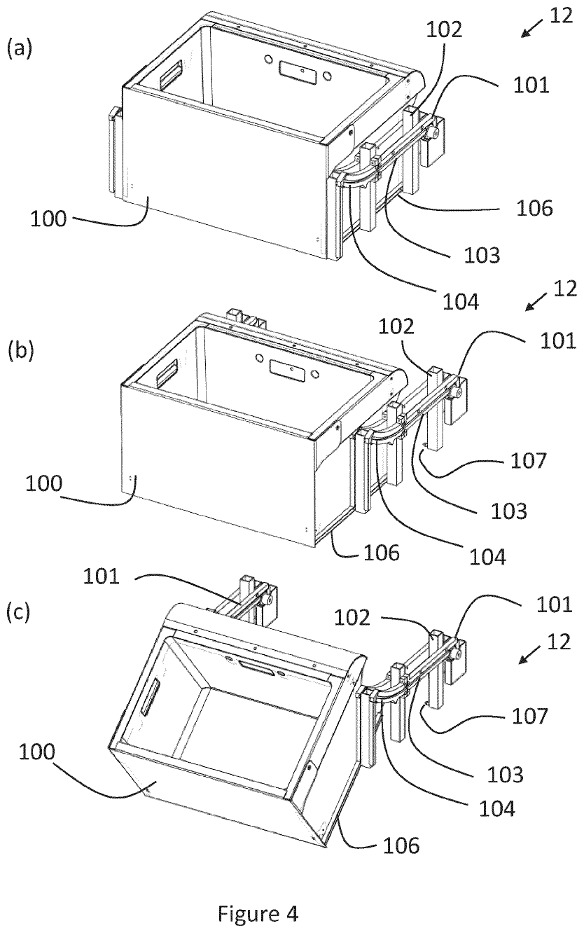

One possible embodiment of a tilting drawer mechanism 12 is illustrated in FIG. 4 (a to c). Although described here as a “tilting drawer mechanism”, the mechanism is not limited to the case where the carrier 100 is a drawer. The carrier 100 in the illustrated example is in the form of an open box, cuboidal in shape, with a base and four side walls, and open at the top. In other examples, the carrier 100 can take different forms, for example a tray or a shelf, or a box with a removable lid.

The movement of the carrier 100 is constrained by a guide 101. The carrier 100 comprises a traveler (not seen in the figure), which is configured to slide along the guide 101 in order to guide the movement of the carrier 100. In the illustrated example, a pair of guides 101 are disposed on opposite sides of the carrier 100. The guide 101 is supported by posts 102, which support two guides 101 on opposing sides of the posts 102 in order to guide two adjacent carriers 100. The guide 101 has a substantially horizontal portion 103, which guides the carrier 100 outwards in a substantially horizontal direction, and an upturned portion 104, which guides the carrier 100 to tilt downwards.

The weight of the carrier 100 is supported by a runner 106 attached to the bottom of the side of the carrier 100. The runner 106 is supported by bearings 107 at the base of the posts 102. When the traveler of the carrier 100 moves along the horizontal portion 103 of the guide 101, the runner 106 rests on the bearings 107. When the traveler of the carrier 100 moves along the upturned portion 104 of the guide 101, the carrier 100 tilts downwards, and the runner 106 pivots on one of the bearings 107.

In FIG. 4(a) the carrier 100 is in its stowed position. In FIG. 4(b) the carrier 100 is in an intermediate position between the stowed position and the deployed position. The traveler is still in the horizontal portion 103 of the guide 101, and the carrier 100 is substantially horizontal. The runner 106 is supported by more than one of the bearings 107 on the posts 102. In FIG. 4(c) the carrier 100 is in the deployed position. The traveler is at the top of the upturned portion 104 of the guide 101. The carrier 100 has tilted forwards and downwards, with the runner 106 at the base of the carrier 100 pivoting on one of the bearings 107.

Depending on the exact shape of the upturned portion 104 of the guide 101, in moving between the intermediate position and the deployed position, the motion of the carrier 100 can either be a pure pivoting motion on the one of the bearings 107, or the motion can be a combination of pivoting motion about the bearing 107 and a sliding motion of the runner 106 along the bearing 107.

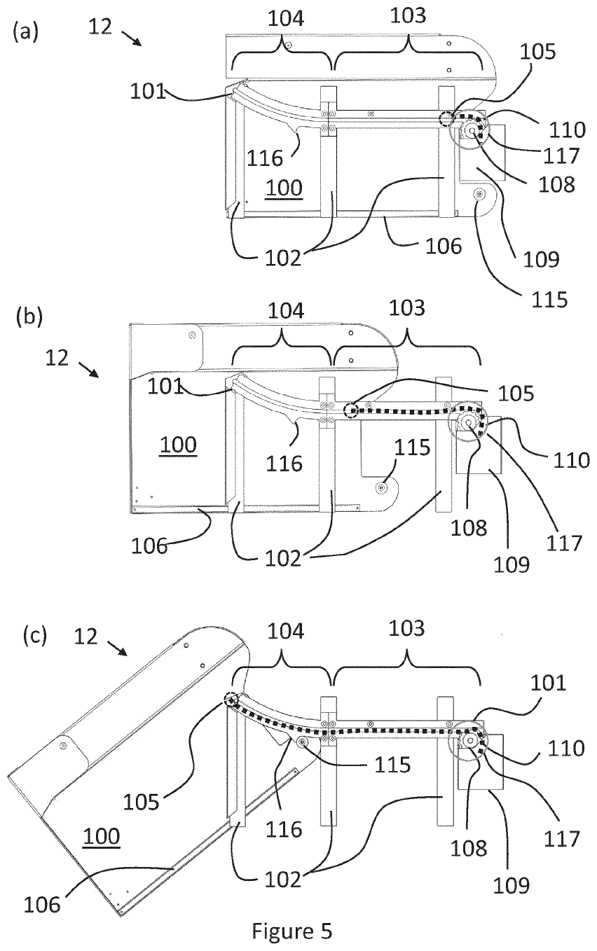

FIG. 5 (a to c) shows a side view of the tilting drawer mechanism 12 of FIG. 4, in (a) the stowed position, (b) an intermediate position, and (c) the deployed position. The traveler 105 is illustrated as a dotted circle. The traveler 105 is secured to the side of the carrier 100, and slides within the guide 101 to enable the carrier 100 to move relative to the guide 101. In FIG. 5(a), the carrier 100 is in the stowed position and the traveler 105 is at the rear of the horizontal portion 103 of the guide 101. In

FIG. 5(b), the carrier 100 is in the intermediate position and the traveler 105 is towards the front of the horizontal portion 103 of the guide 101. In FIG. 5(c), the carrier 100 is in the deployed position and the traveler 105 is at the front/top of the upturned portion 104 of the guide 101.

In order to stop the carrier 100 in the deployed position and prevent the carrier from tilting further, the carrier 100 is provided with a protrusion 115, and the guide 101 is provided with a stop 116. When in the deployed position, the protrusion 115 on the carrier 100 abuts against the stop 116 on the guide 101. It can be seen in FIG. 5(c) that the protrusion 115 is in contact with the stop 116.

In some examples, the movement of the tilting drawer mechanism 12 may be automated. FIG. 5(a to c) illustrates one example of a tilting drawer mechanism 12 that can be used to deploy and to retract the carrier 100. The traveler 105 on the side of the carrier 100 is connected to a distal end of a chain 110. The chain 110 passes through the guide 101 and over a sprocket 108 at the rear end of the guide 101 and into a container 109. The sprocket 108 is turned by a motor 117. In order to move the carrier 100 from the stowed position into the deployed position, the sprocket 108 turns and pushes the chain 110 along the guide 101, and the distal end of the chain 110 in turn pushes the traveler 105 along the guide 101, so the carrier 100 moves forwards. In order to retract the carrier 100 from the deployed position back into the stowed position, the sprocket 108 turns in the opposite direction and pulls the chain 110 back along the guide 101, which in turn pulls the traveler 105 along the guide 101, so the carrier 100 moves backwards. The guide 101 constrains the chain 110 to keep the chain 100 sufficiently rigid to be pushed, as well as pulled. Without the guide 101, the chain 110 would deform when pushed by the rotation of the sprocket 108, rather than transfer the force to the distal end of the chain 110 and push the traveler 105 along the guide 101.

In FIG. 5 (a to c), the traveler 105 (i.e. the connection point of the chain 110 to the carrier 100) is illustrated as being located at a position towards the top and towards the rear of the side of the carrier 100. In other examples, the traveler 105 may be connected to the carrier 100 at a different position on the carrier 100. The shape and position of the guide 101, along with the position of the traveler 105 on the carrier 110, can be varied in order to define the path that the carrier 100 takes between the stowed position and the deployed position.

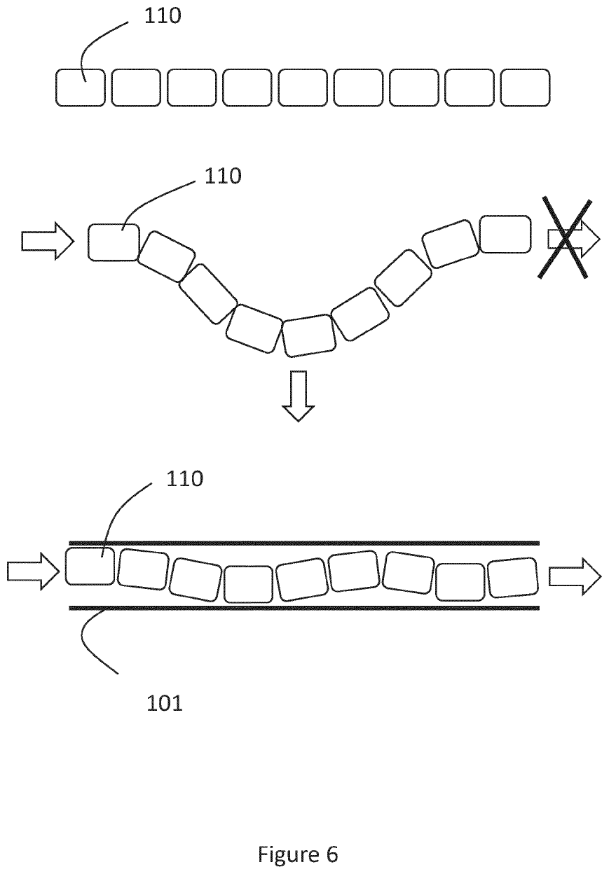

FIG. 6 illustrates the principle of using a chain 110 to push the carrier 100 into the deployed position. When the chain 110 is unconstrained, applying a force to one end results in the chain 110 deforming rather than transferring the force. However, when the chain 110 is constrained by the guide 101, applying a force to one end of the chain results in the force being transferred to the other end of the chain. The guide 101 limits the lateral movement of the chain, so the pushing force is transferred. Therefore the guide 101 enables the chain 110 to be used both to push (i.e. to move the carrier 100 from the stowed position to the deployed position) and to pull (i.e. to retract the carrier 100 from the deployed position to the stowed position).

In other examples, a different mechanism can be used to automate the movement of the tilting drawer mechanism 12. For example, a belt drive or a rope can be used as alternatives to the chain in the illustrated example.

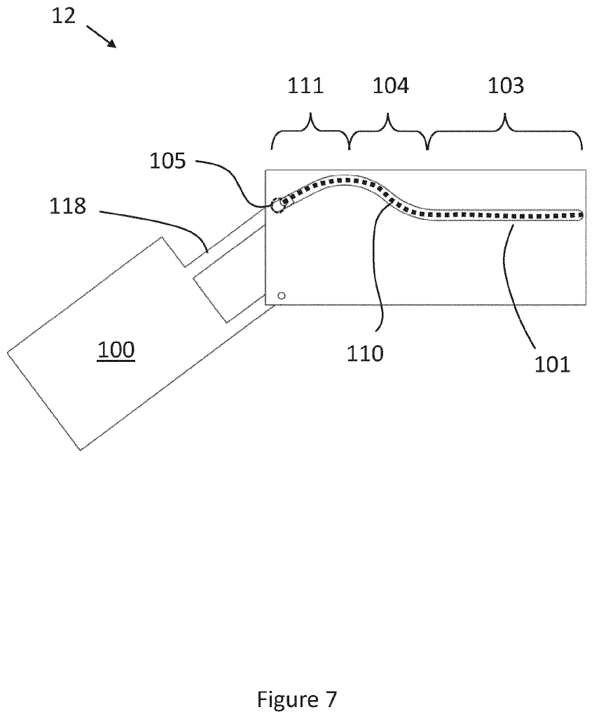

The tilting drawer mechanism 12 illustrated in FIG. 7 has a guide 101 comprising a substantially horizontal portion 103, an upturned portion 104, and a downturned portion 111. In the illustrated example, the downturned portion 111 of the guide 101 enables the carrier 100 to slide farther out and farther down, while remaining at around the same angle to the horizontal as when the traveler 107 has traversed the upturned portion 104. In other examples, the downturned portion 111 of the guide 101 may be shaped such that the carrier 101 tilts farther forwards.

In FIG. 7, the traveller 105 (i.e. the connection point of the chain 110 to the carrier 100) is illustrated as being located on an arm 118, which extends from the main body of the carrier 100. In other examples, the traveller 105 may be connected to the carrier 100 at a different position on the carrier 100. The shape and position of the guide 101, along with the position of the traveller 105 on the carrier 110, can be varied in order to define the path that the carrier 100 takes between the stowed position and the deployed position. In the example of FIG. 7, the location of the traveller 105 on the distal end of the arm 118 enables the carrier 100 to move farther out and tilt farther downwards.

In some examples, both the first-type storage devices and the second-type storage devices on the vehicle can be tilting drawer mechanisms 12. The second row of second-type storage devices can be tilting drawer mechanisms 12 with a guide 101 comprising a substantially horizontal portion 103, an upturned portion 104, and a downturned portion 111, as illustrated in FIG. 7. The first row of first-type storage devices can be tilting drawer mechanisms 12 with a guide 101 comprising a substantially horizontal portion 103 and an upturned portion 104, but without a downturned portion 111. The second carriers of the second-type storage devices in the second deployed position are farther forwards and farther down because of the downturned portion 111, whereas the first carriers of the first-type storage devices do not descend as far downwards in the first deployed position, because of the absence of the downturned portion 111 in the guides 101 of the first-type storage devices. This configuration achieves the aim of presenting the first carriers and second carriers at a convenient height to retrieve an order, while also having the advantage that the first-type storage devices and second-type storage devices are very similar in design; the only differences are that the guides 101 of the second-type storage devices comprise a downturned portion 111 and the guides 101 of the first-type storage devices do not, and the second-type storage devices comprise an arm 118 with the traveler 105 located on the distal end of the arm 118 whereas the first-type storage devices have the traveler 105 located on the main body of the first carrier 100. The similarity of the first-type storage device sand second-type storage devices results in a simpler design, with fewer unique parts, and therefore results in a simpler and less expensive vehicle design.

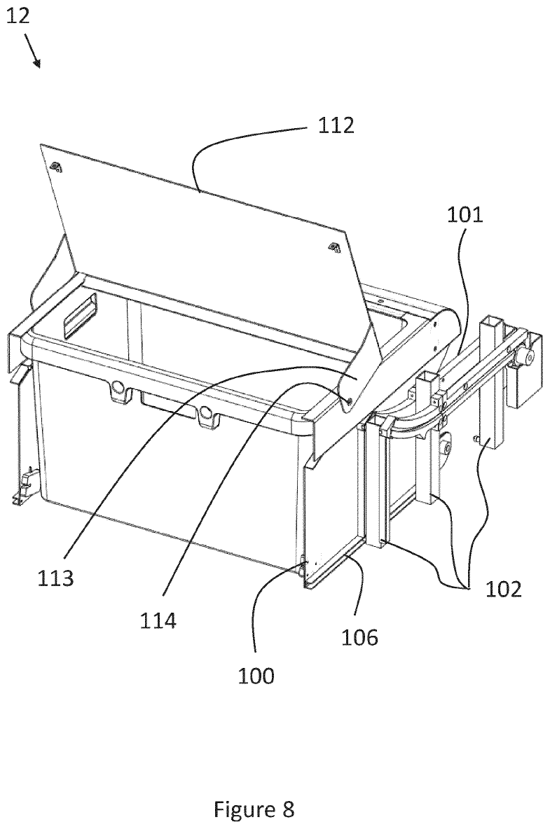

In some examples, the carrier 100 may be configured for automatic loading, for example automatic loading or unloading of goods from a warehouse directly into a vehicle. For example, orders in storage containers can be loaded into the carriers on the vehicle at a warehouse, and after the orders have been delivered the vehicle can return to the warehouse and empty storage containers can be unloaded from the vehicle. To facilitate loading and unloading, the carrier 100 illustrated in FIG. 8 comprises a front face 112 that can be lifted up, in order to provide access to the inside of the carrier 100 from the front of the carrier 100. The front face 112 comprises a pair of opposing flanges 113 that extend substantially perpendicularly to the plane of the front face 112. Each of the opposing flanges is pivotably connected to a side wall of the carrier 100 by a pivot 114. The pivot enables the front face 112 to be rotated upwards, leaving unobstructed access to the inside of the carrier 100. Automatic loading is particularly convenient for warehouses that use a standard size storage container.

In other examples, a storage container can be manually loaded into the carrier 100 when the front face 112 is lifted up.

In examples where the rows of storage devices are arranged on the sides of the vehicle as illustrated in FIGS. 1 to 3, goods or storage containers can be loaded or unloaded from the side of the vehicle.

Although the front face 112 that can be lifted up for manual or automatic loading/unloading is illustrated as applied to a particular embodiment of the tilting drawer mechanism, this feature can equally be applied to other examples of the tilting drawer mechanism and/or drop-down drawer mechanism and/or other implementations of the first-type or second-type storage device.

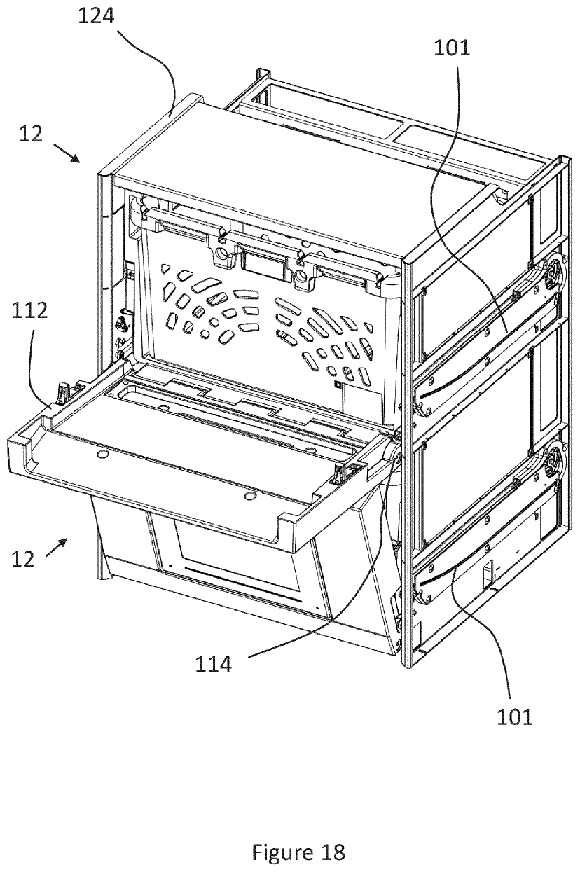

FIG. 18 schematically illustrates a unit comprising two tilting drawer mechanisms 12 of the type described above with reference to FIG. 4-8. The two tilting drawer mechanisms share an outer shell 124, which supports the guides 101. One or more units may be installed on a vehicle similar to that illustrated in FIGS. 1-3, either alone or in combination with other types of storage device.

Both carriers 100 have a front face 112 that is moveable in order to facilitate loading and unloading. The front face 112 illustrated in FIG. 18 is different from that of FIG. 8 in that the front face is pulled down rather than lifted up in order to provide access to the inside of the carrier 100 from the front of the carrier 100. The front face 112 is pivotably connected to a side wall of the carrier 100 by a pivot 114. The pivot enables the front face 112 to be rotated downwards, leaving unobstructed access to the inside of the carrier 100.

The feature of a front face 112 that is moveable relative to the carrier 100 can be applied to any embodiment of the tilting drawer or the drop-down drawer. In any of the examples described herein, or in other examples, the front face 112 can be pulled down (as in FIG. 18), lifted up (as in FIG. 8), or otherwise moved relative to the carrier 100.

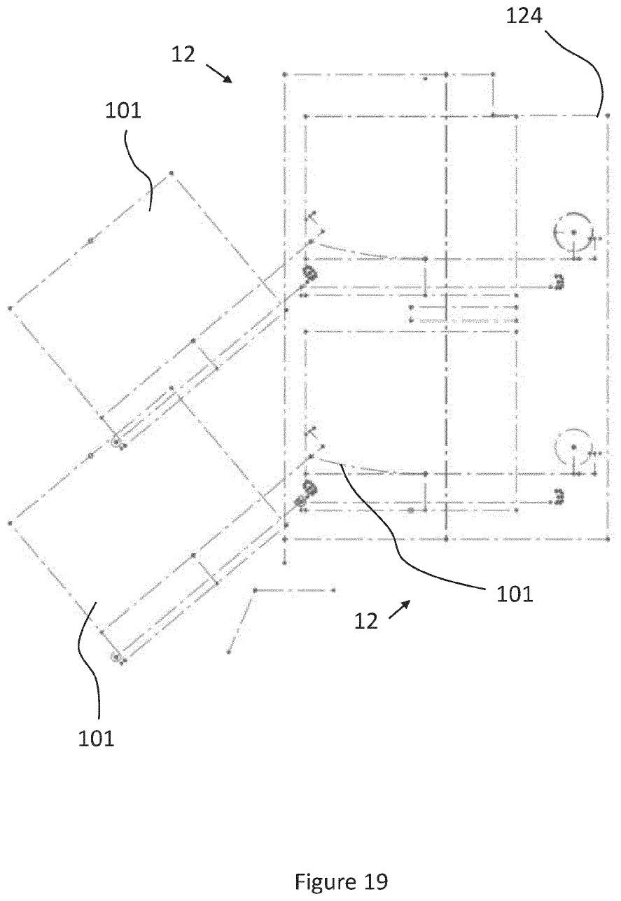

FIG. 19 schematically illustrates a side view of the unit of FIG. 18 with both carriers 100 in the deployed position. It can be seen that the spatial volume occupied by the two carriers 100 when in the deployed position are overlapping slightly. In other embodiments, the spatial volume occupied by the carriers 100 may not overlap when in the deployed position, or the spatial volume occupied by the carriers 100 may overlap at some point along the path between the stowed position and the deployed position.

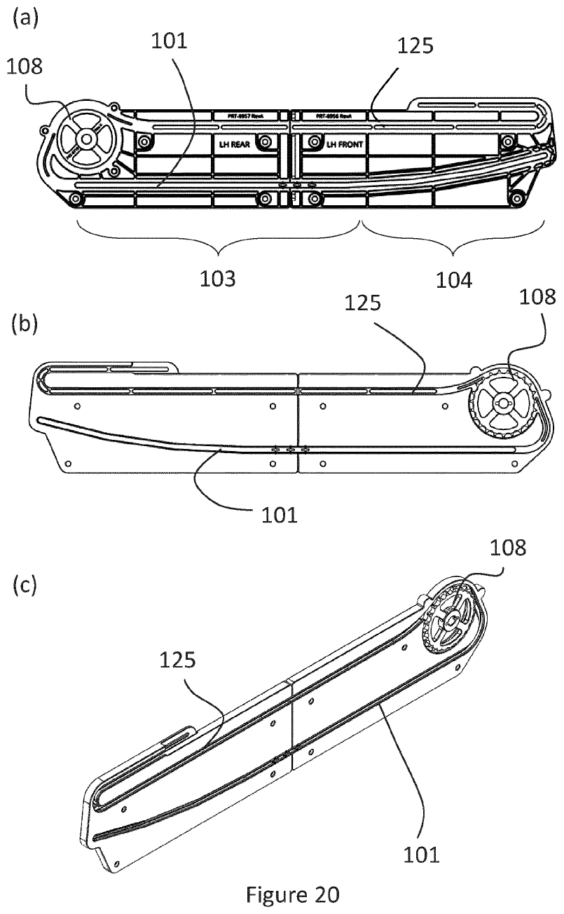

FIG. 20 schematically illustrates a piece of the tilting drawer mechanism 12 of FIG. 18, in (a) side view from the inside of the outer shell (b) side view from the outside of the outer shell, and (c) perspective view. The piece comprises the guide 101 and a further chain guide 125. The horizontal portion 103 and the upturned portion 104 of the guide 101 are labelled in FIG. 20(a).

In this example, the chain is guided by both the guide 101 and the chain guide 125. This is different from the example in FIG. 5 where a single guide 101 acts as both the guide for the traveler and the guide for the chain, and also different from the second embodiment of the tilting drawer mechanism where the guide comprises runners and the chain is guided by a separate chain guide, as will be discussed later.

The chain guide 125 is a channel that is open on one side (the outside) as can be seen in FIG. 20(b), and partially shielded on the other side (the inside) as can be seen in FIG. 20(a). An advantage of this arrangement is that the chain can be shielded from the inside of the outer shell 124 rather than the chain being exposed, therefore reducing the risk that any other part gets caught on the chain. Advantageously, when in the stowed position the traveler is at the back of the guide 101, so the chain is substantially contained within the chain guide 125 in a controlled/constrained manner leading to higher reliability. This arrangement has an advantage over the example illustrated in FIGS. 5 and 8 in that the chain is constrained within the chain guide 125 rather than being contained within the container 109 in a less constrained manner.

A chain (not shown for clarity) passes along the chain guide 125, over a sprocket 108 at the rear of the unit, and back along the guide 101. The sprocket 108 is turned by a motor 117. In order to move the carrier 100 from the stowed position into the deployed position, the sprocket 108 turns and pushes the chain along the guide 101 so the carrier 100 moves forwards. The chain is pulled along the chain guide 125 at the same time as being pushed along the guide 101. In order to retract the carrier 100 from the deployed position back into the stowed position, the sprocket 108 turns in the opposite direction and pulls the chain back along the guide 101 so the carrier 100 moves backwards. The chain is pushed along the chain guide 125 at the same time as being pulled along the guide 101. The guide 101 and the chain guide 125 constrain the chain to keep the chain sufficiently rigid to be pushed as well as pulled. It can be seen from FIG. 20 that the chain guide 125 is shaped such that there is a portion at the front which reverses in direction. This allows sufficient space to accommodate the full length of the chain when the carrier is in the stowed position.

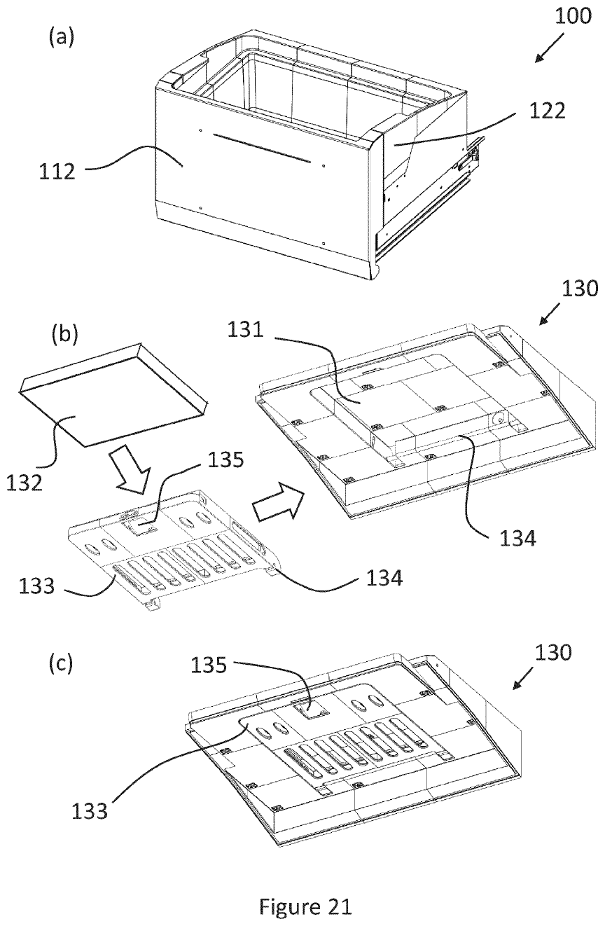

In some examples, delivery vehicles can be used for the delivery of chilled or frozen goods, for example groceries. Drawers that are insulated and/or that hold eutectic elements can be used to maintain goods at a low temperature for a period of time. FIG. 21 illustrates (a) a drawer or carrier 100 with insulated side walls, and a lid 130 for the carrier, eutectic plate 132, and plate holder 133 in (b) exploded view, and (c) assembled view. As can be seen in FIG. 21(a), the carrier 100 has thick side walls 122, front face 112, rear face, and base to accommodate insulating material.

A lid 130 is provided to cover the opening of the carrier 100 and provide further insulation and cooling, as illustrated in FIG. 21(b) and(c). The lid 130 is attached to the outer shell 124 by any appropriate fastening means (not shown). It can be seen from FIG. 21 that both the carrier and the lid have a sloping rim. The sloping rim facilitates the carrier moving between the stowed position, in which the lid 130 is engaged with the carrier 100, and the deployed position, in which the carrier is open at the top to provide access to the inside of the carrier 100, and the lid 130 remains attached to the outer shell 125. The rim of the carrier 100 and/or the lid 130 may be provided with a seal, so that when in the stowed position the lid 130 seals against the carrier 100 in order to maintain the temperature inside the carrier 100. Any appropriate seal can be used, for example a rubber seal.

The lid 130 also comprises insulating material, and a cavity 131 on the underside for holding a eutectic plate 132. The eutectic plate 132 is secured in place by a plate holder 133, which is receivable within the cavity 131. The plate holder 133 is in the form of a shallow tray, upon which the eutectic plate 132 can be placed. Apertures in the plate holder 133 ensure that air within the carrier 100 can pass through the apertures and over the eutectic plate 132, in order to provide a cooling effect to the air within the carrier 100. The plate holder 133 is releasably attachable to the lid 130 by means of a hinge 134. In this example, the hinge is formed by two hook-shaped protrusions on the plate holder 133, which hook over a horizontally extending bar within the cavity 131. The plate holder 133 is secured to the lid 130 using a suitable fastening means 135 (which could, for example, be a magnet or a catch).

The front face 112 of the carrier 100 can be pulled downwards, as discussed above with reference to FIG. 18. In examples where the carrier is provided with a lid 130 with a eutectic plate 132, this arrangement is particularly advantageous because opening the front face 112 provides convenient access to the lid 130 when the carrier 100 is in the stowed position. The front face 112 may be provided with a latching mechanism to retain the front face 112 in the closed position.

In use, to change the eutectic plate 132 (for example, before a delivery vehicle departs on a delivery route), firstly the front face 112 is unlatched and pulled down to provide access to the interior of the carrier 100. If a storage container or other goods are present in the carrier 100, they may need to be removed to give access to the bottom portion of the lid 130. The fastening means 135 is released, and the plate holder 133 pivots downwards about the hinge 134, so that the eutectic plate 132 can be removed and replaced with a fresh eutectic plate., the plate holder 133 with the fresh eutectic plate is then moved back into the cavity 131 in the lid 130 and secured with the fastening means 135. The front face 112 can then be latched into its closed position, and a storage container or other goods may be replaced or otherwise inserted into the carrier 100.

The specific example illustrated in FIG. 21 is not intended to be limiting, and other suitable arrangements of insulation and/or one or more eutectic elements can be used. The feature of eutectic elements and/or of a lid secured to an outer shell can be applied to any embodiment of the tilting drawer or the drop-down drawer.

### Tilting Drawer Mechanism—Second Embodiment

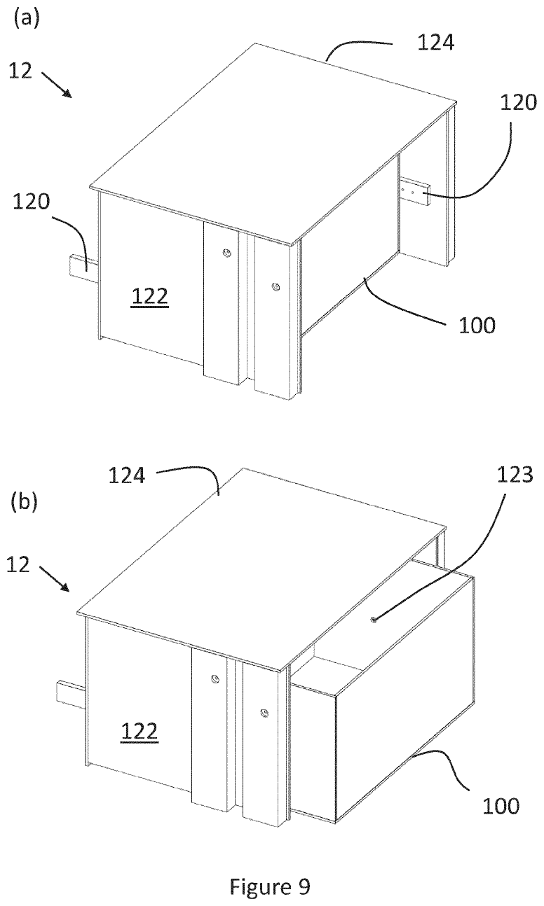

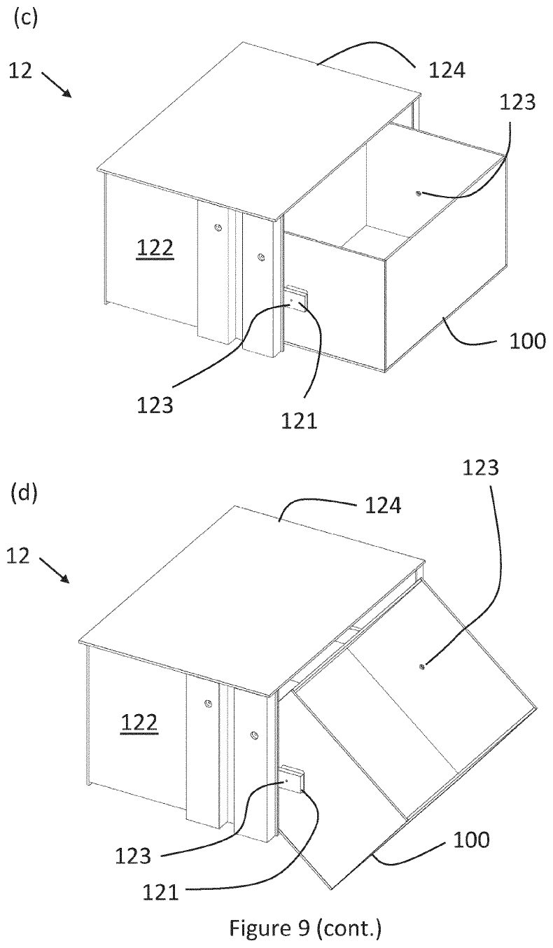

In another embodiment as illustrated in FIG. 9 (a to d), the tilting drawer mechanism 12 comprises a carrier 100 and runners 120 that guide the carrier 100 in a substantially horizontal direction between the stowed position and the deployed position. Two sets of runners are provided, on opposite sides of the tilting drawer mechanism 12.

As with the first embodiment, the carrier 100 is in the form of an open box, cuboidal in shape, with a base and four side walls, and open at the top. In other examples, the carrier 100 can take different forms, for example a tray or a shelf, or a box with a removable lid.

The distal end 121 of the runners is pivotally connected to the side walls 122 of the carrier 100 via pivots 123. The pivots 123 allow the carrier 100 to rotate relative to the runners 120.

The carrier 100, when in the stowed position, is received within an outer shell 124 in the form of an open-sided box or channel with a base, a top, and two side walls. When in the deployed position, the carrier 100 is substantially outside the outer shell 124. The outer shell 124 restricts the movement of the carrier 100 to linear horizontal movement along the axis of the outer shell 124, and limits rotational movement of the carrier 100 when the carrier 100 is within the outer shell 124. When the carrier 100 is substantially outside the outer shell 124, the carrier 100 is no longer restricted by the outer shell 124 so is able to tilt downwards/forwards at an angle to the horizontal. In other examples, the carrier 100 can be tilted upwards rather than downwards.

FIG. 9(a) illustrates the carrier 100 in the stowed position, fully within the outer shell 124. The outer shell 124 prevents the carrier 100 from rotating. FIG. 9(b) illustrates the carrier 100 in an intermediate position, partially within the outer shell 124. Again, the outer shell 124 prevents the carrier 100 from rotating. FIG. 9(c) illustrates the carrier 100 in the deployed position. The carrier 100 is mostly outside the outer shell 124, so is no longer prevented from tilting. FIG. 9(d) illustrates the carrier 100 in the deployed position, tilted downwards. The extent of the rotation of the carrier 100 is limited by the outer shell 124, in particular by the base of the outer shell 124. The carrier 100 tilts forward until the base of the tilting carrier 100 abuts against the base of the outer shell 124.

As with the first embodiment of the tilting drawer mechanism 12, the movement of the carrier 100 can be automated, for example by using a chain mechanism. The chain mechanism, as described above with reference to the first embodiment of the tilting drawer mechanism 12 and illustrated in FIG. 5(a to c), can also be applied to the second embodiment of the tilting drawer mechanism 12.

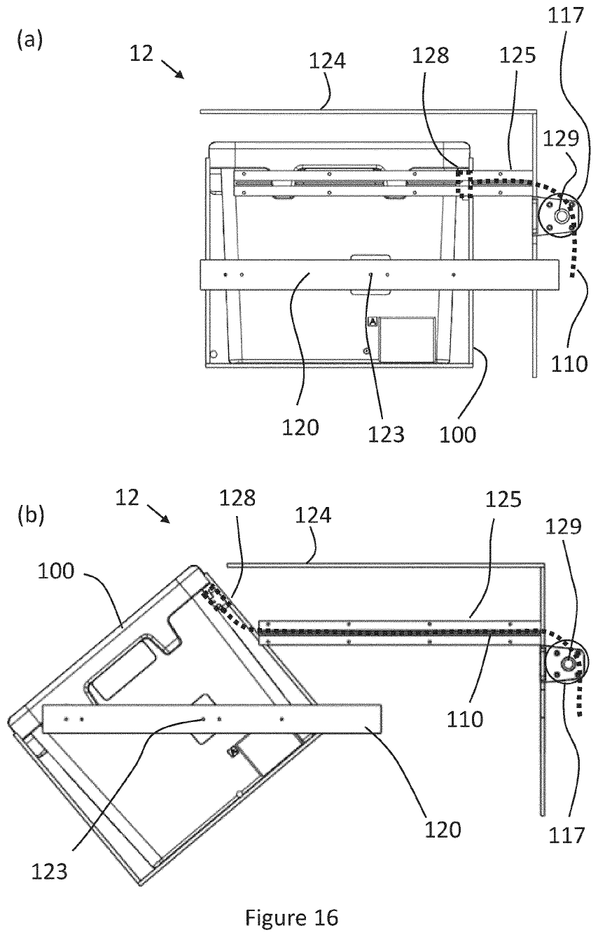

FIG. 16(a and b) illustrates a side view of the tilting drawer mechanism 12 with a separate chain guide 125. Unlike the first embodiment of the tilting drawer mechanism 12, where the guide 101 also acts as a chain guide, in the second embodiment the chain guide 125 is a separate part. The chain guide 125 is provided in order to guide the chain 110 and enable the chain 110 to both push the carrier 100 from the stowed position to the deployed position, and to pull the carrier 100 back from the deployed position to the stowed position, as described above in relation to the first embodiment. As with the first embodiment of the tilting drawer mechanism, the chain guide 125 constrains the chain 110 in order to ensure that the chain 110 is sufficiently rigid to push the carrier 100 as well as pull.

The distal end of the chain 110 is connected to a connector 128, illustrated in FIG. 16 (a and b) with a dotted rectangle. The chain engages with a sprocket 129. The connector 128 is attached to the rear of a side face of the carrier 100. The connector 128 is constrained to slide within the chain guide 125 when the carrier 100 is between the stowed position and the intermediate position, so also helps to guide the carrier 100. When the carrier 100 pivots downwards from the intermediate position to the deployed position, the connector 128 exits the front end of the chain guide 125 in order to permit the carrier 100 to pivot downwards. To retract the carrier 100 from the deployed position back to the stowed position, the sprocket 129 is rotated so that the chain 110 is pulled back. The connector 128 attached to the distal end of the chain 110 is therefore also pulled back, until the connector 128 re-engages with the front end of the chain guide 125 when the carrier 100 reaches the intermediate position. Further rotation of the sprocket 129 pulls the connector 128 back along the chain guide 125, thus retracting the carrier 100 back to its stowed position.

FIG. 16(a) illustrates the carrier 100 in the stowed position, with the chain 110 fully retracted. The carrier 100 is fully within the outer shell 124, and the runners 120 are in a retracted position. The connector 128 is enclosed within the chain guide 125.

FIG. 16(b) illustrates the carrier 100 in the deployed position, with the chain 110 fully extended. The chain 110 passes all the way through the chain guide 125 and out of the front of the chain guide 125. The connector 128 is outside the chain guide 125 and the carrier 100 has tilted forwards, about the pivot point 123 on the runner 120. The runner 120 is in a fully extended position.

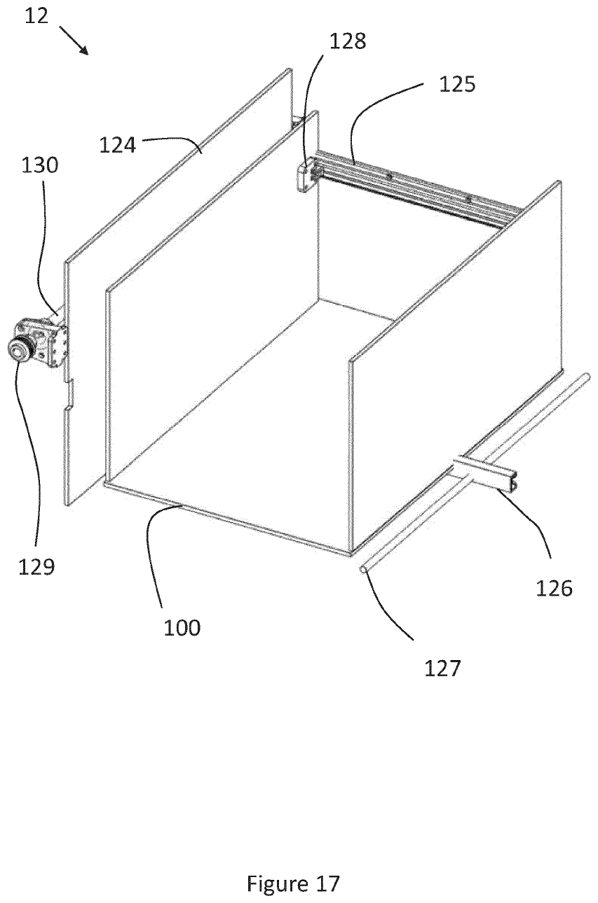

FIG. 17 illustrates a different view of the tilting drawer mechanism 12 of FIG. 16, with the side faces of the carrier 100 and most of the outer shell 124 removed for ease of visualization. The connector 128 can clearly be seen, engaged with the chain guide 125. In the illustration, the carrier 100 is in the stowed position.

Also illustrated in FIG. 17 is a support rail 126 running on roller bearings 127. The support rail 126 and bearings 127 support the carrier 100 so that the runner 120 and chain guide 125 do not need to support the whole weight of the carrier 100 and any goods/items contained within the carrier 100. The support rail 126 also helps to guide the movement of the carrier 100 in the horizontal direction, between the stowed position and the intermediate position. The support rail 126 as illustrated in FIG. 17 is a single support rail provided in the center of the carrier 100. The support rail 126 is secured to the underside of the carrier 100, and supported by long roller bearings 127. Although only one roller bearing 127 is illustrated, in practice there may be a series of roller bearings 127 distributed between the front and the back of the outer shell 124, such that the support rail 126 is supported by two or more bearings as the carrier 100 moves between the stowed position and the intermediate position.

Two chain guides 125 with two chains 110 and two connectors 128 and two sprockets 129 are provided on opposite sides of the carrier 100, in order to ensure stability and to distribute the weight of the carrier 100 more evenly. In FIG. 17, for clarity, the chain guide 125 and connector 128 are illustrated on one side only. The sprockets 129 are mounted on an axle 130, positioned behind the rear face of the outer shell 124. The axle 130 can be turned by a motor 117 (shown on FIG. 16), for example via a belt around the output of the motor 117 and the axle 130. The two sprockets being mounted on the same axle 130 means that the two chains 110 on opposite sides of the carrier 100 are pulled with equal force, again ensuring the stability of the tilting drawer mechanism as the carrier 100 moves between the stowed position, the intermediate position, and the deployed position.

### Drop-Down Drawer Mechanism

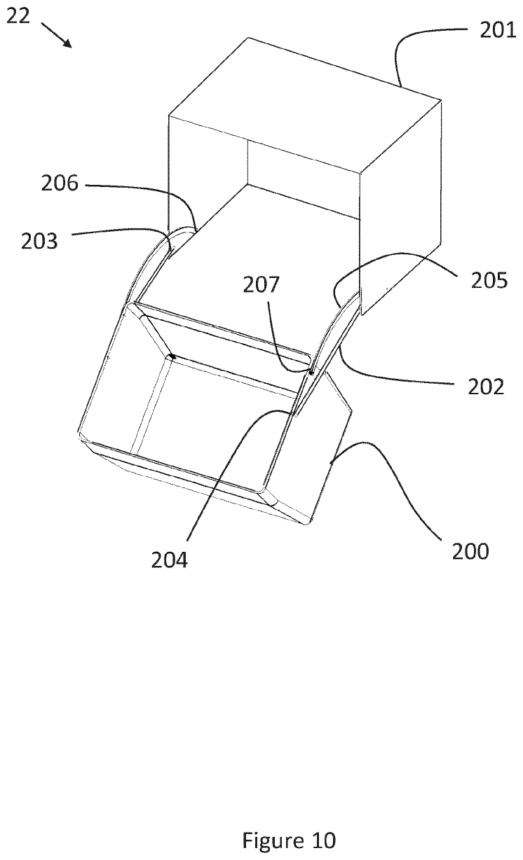

In the illustrated example of FIG. 3, the second-type storage device 22 is a drop-down drawer mechanism comprising a carrier 200 configured to move outwards and downwards relative to the vehicle 1, and then tilt. In the illustrated example the carrier 200 is tilted downwards, but in other examples the carrier 200 could be tilted upwards. Although described as a “drop-down drawer mechanism”, the carrier 200 is not limited to being a drawer. In the example illustrated in FIG. 10, the carrier 200 is in the form of an open box, cuboidal in shape, with a base and four side walls, and open at the top. In other examples, the carrier 200 can take different forms, for example a tray or a shelf, or a box with a removable lid.

FIG. 10 is a schematic illustration of one possible embodiment of a drop-down drawer mechanism 22. In the illustrated example, the carrier 200 is configured to move outwardly and downwardly from its closed position (stowed position) to its open position (deployed position). In the deployed position, the carrier 200 is substantially outside the footprint of the vehicle 1 and also tilted downwards, such that the carrier 200 is presented at an angle to the horizontal. The lower height and tilted angle mean that the contents of the carrier 200 are presented in a convenient way to retrieve, without the need to lift potentially heavy items down from a significant height, which would carry the risk of dropping the items.

In the illustrated example, the drop-down drawer mechanism 22 comprises a carrier 200 and an outer shell 201. When in the stowed position, the carrier 200 is contained within the outer shell 201. The outer shell 201 takes the form of an open-sided box with three side walls and a top. In other examples, the carrier 200 and the outer shell 201 can take different forms—for example, the outer shell could be a shelf upon which the carrier 200 rests when in the stowed position.

In the illustrated example the carrier 200 is connected to the outer shell 201 by two pairs of linkages. A first linkage 202 is pivotably connected at a first end 203 to the outer shell 201 and pivotally connected at a second end 204 to the carrier 200. A second linkage 205 is pivotably connected at a first end 206 to the outer shell 201 and pivotally connected at a second end 207 to the carrier 200. The first linkage 202 is straight, and the second linkage 205 is curved. The curved shape of the second linkage 205 prevents the second linkage 205 from obstructing the first linkage 202 as the carrier 200 is moved to the deployed position. In this particular embodiment the second linkage 205 is curved, but any other shape (e.g. angled) that serves the same purpose is permitted.

In order to ensure stability and a more even distribution of forces, in the illustrated example a pair of first linkages 202 and a pair of second linkages 205 are provided, with one first linkage 202 and one second linkage 205 attached to each side of the carrier 200.

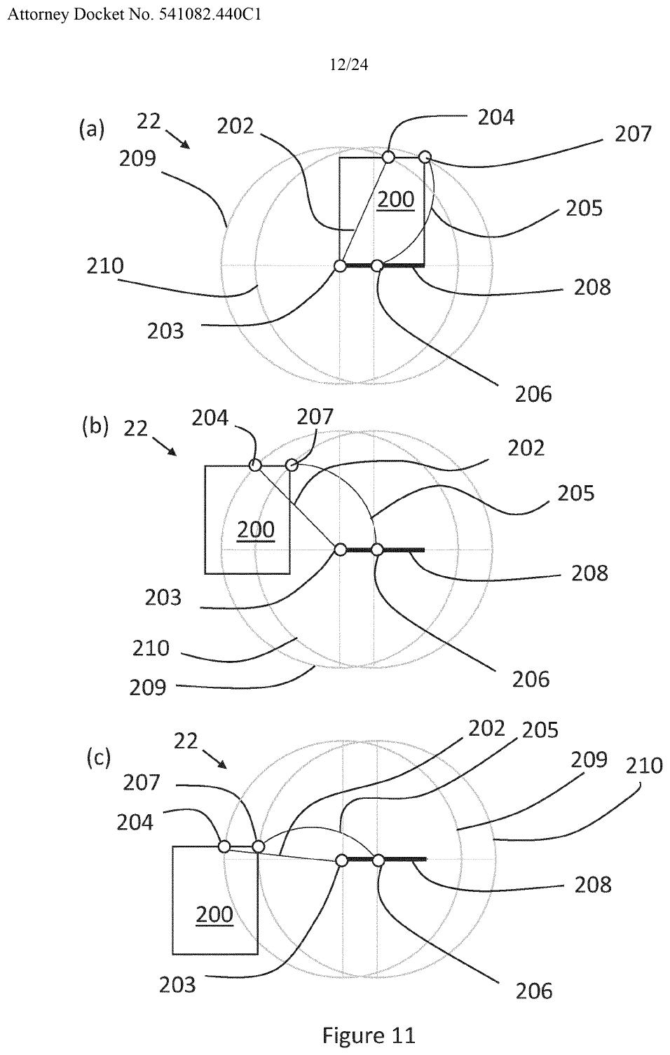

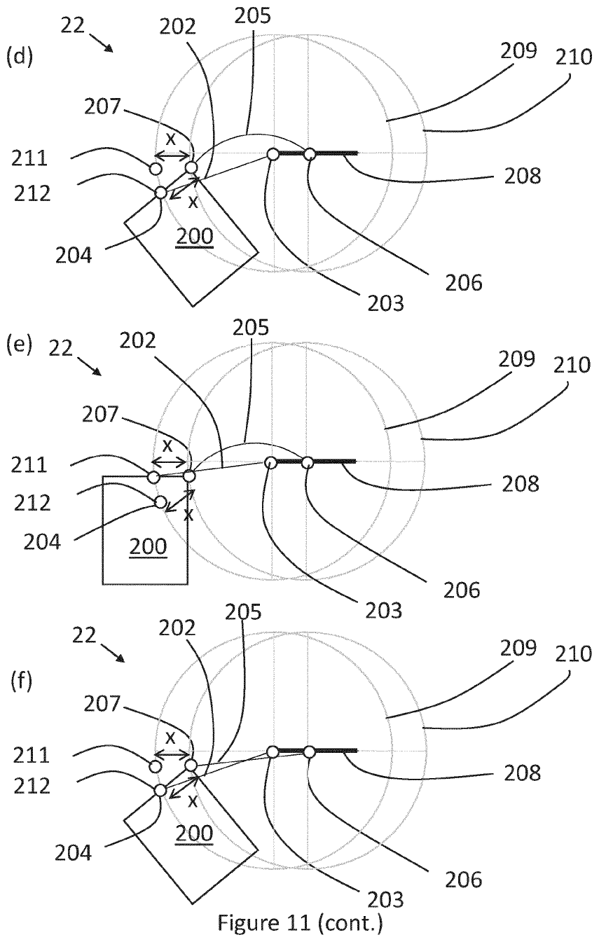

FIG. 11 (a to f) is a schematic illustration of a carrier mechanism 22, viewed from the side, in different positions. As with FIG. 10, the carrier 200 is connected via two linkages, a first linkage 202 and a second linkage 205. The second linkage 205 is curved, as will be discussed in more detail later. The small circles 203, 204, 206, 207 represent the pivot points located at the first end 203 and second end 204 of the first linkage 202, and the first end 206 and second end 207 of the second linkage 205. The bold horizontal line 208 is a base, which could represent a shelf on a vehicle or part of the outer shell. The carrier 200 rests upon the base 208 while in the stowed position.

Since the linkages are of fixed length, the paths or loci of the second end 204 of the first linkage 202 and the second end 207 of the second linkage 205 are circular. The second end 204 of the first linkage 202 follows a first path that is part of a circle 209 centred on the first end 203 of the first linkage 202. The second end 207 of the second linkage 205 follows a second path that is part of a circle 210 centered on the first end 206 of the second linkage 205. The large circles 209, 210 in FIG. 11 represent the paths or loci of the second ends 204, 207 of the first and second linkages 202, 205 respectively.

In FIG. 11(a), the carrier 200 is in the stowed position, resting on the base 208. In FIG. 11(b), the carrier 200 has moved part of the way along its circular path 209, 210, and is at a lower vertical level than in the stowed position. In FIG. 11(c), the carrier 200 has moved farther along its circular path 209, 210 and has dropped down farther, and the first and second linkages 202, 205 are almost horizontal. In all of FIGS. 11(a),(b) and(c), the two pivot points at the second ends 204, 207 of the first 202 and second 205 linkages respectively are at the same vertical level, so the carrier 200 remains level.

In this description, “the horizontal” is used to mean the horizontal plane of the base of the carrier 200 when the carrier 200 is in the stowed position. This coincides with the horizontal plane of the base 208. When the linkages 202, 205 are described as “below the horizontal”, this term is used to mean that the second end 204, 207 is at a lower vertical level than the first end 203, 206, i.e. the first linkage 202 is below the horizontal when the second end 204 of the first linkage 202 is vertically below the first end 203 of the first linkage, and the second linkage 205 is below the horizontal when the second end 207 of the second linkage 205 is vertically below the first end 206 of the second linkage.

As the linkages 202, 205 rotate farther and the carrier 200 drops below the horizontal, there are two positions that satisfy the geometric constraints imposed by the particular arrangement of linkages as illustrated. The first geometric constraint is that the two pivot points at the second ends 204, 207 of the first 202 and second 205 linkages respectively must be a fixed distance from the first ends 203, 206 of the first 202 and second 205 linkages respectively, i.e. the distance is fixed by the length of the linkages 202, 205 and the second ends 204, 207 are constrained to follow the circular paths or loci 209, 210 respectively. The second geometric constraint is that the distance (labelled as x on FIG. 11 (d to f)) between the two pivot points at the second ends 204, 207 of the first 202 and second 205 linkages respectively is fixed, because the two ends are pivotally connected to the carrier 200. When the linkages 202, 205 drop below the horizontal, for a given position of the pivot point 207 at the second end of the second linkage 205, there are two possible positions of the pivot point 204 at the second end of the first linkage 202. These two positions are labelled on FIGS. 11(d to f) as 211 and 212, which will be referred to as the upper position 211 and the lower position 212. It can be seen from the figure that both of these positions 211 and 212 lie on the circular path or locus 209 of the first linkage 202, and the distance between each of the two positions 211 and 212 and the pivot point 207 at the second end of the second linkage 205 is x. Therefore the pivot point 204 at the second end of the first linkage 202 can occupy either position 211 or 212 while satisfying the geometric constraints imposed by the fixed length of the linkages 202, 205 and the fixed distance x between the two pivot points 204, 207 at the first ends of the two linkages 202, 205.

FIG. 11(d) illustrates the position of the carrier 200 below the horizontal, with the pivot point 204 at the second end of the first linkage 202 in the lower position 212. The pivot point 204 in the lower position 212 is at a lower vertical level than the pivot point 207 at the first end of the first linkage 205. The carrier 200 therefore tilts downwards.

FIG. 11(e) illustrates the position of the carrier 200 below the horizontal with the pivot point 204 at the second end of the first linkage 202 in the upper position 211. It can be seen from the figure that the two linkages 205 and 202 would clash so although the upper position 211 satisfies the geometric constraints, with the configuration of linkages as illustrated, the carrier 200 cannot remain level and would tilt downwards so that the pivot point 204 at the second end of the first linkage 202 would occupy the lower position 211.

Even if the first linkage 202 were curved in the opposite direction, i.e. shaped so as to avoid clashing with the second linkage 205, the weight of the carrier 200 would pull the drop-down carrier 200 down so that the pivot point 204 at the second end of the first linkage 202 would occupy the lower position 212 rather than the upper position 211.

The curved shape of the second linkage 205 is necessary in order to avoid obstructing the first linkage 202 as the linkages rotate downwards below the horizontal. As illustrated in FIG. 11(f), if the second linkage 205 were a straight member rather than curved, the linkages would not be able to move below the horizontal because the first linkage 202 would obstruct the movement of the second linkage 205. Although the second linkage 205 is illustrated as having a curved shape in this example, any shape (e.g. curved or angled) that allows the first linkage 202 to rotate downwards without obstructing the first linkage 202 is applicable.

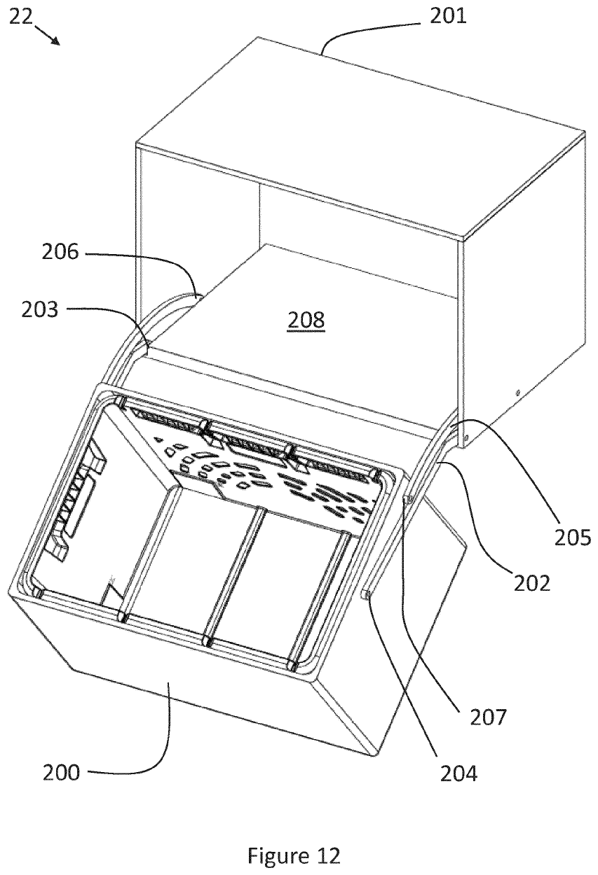

FIG. 12 illustrates another example of a drop-down drawer mechanism 22. In this example, the first linkage 202 is angled, comprising two substantially straight portions, and the second linkage 205 is curved. The purpose of the angled shape of the first linkage 202 is twofold: the shorter straight portion of the first linkage 205 rests on the base 208 of the outer shell 201; and the curved second linkage 205 rests on the angled second linkage at two contact points, rather than a single contact point as would be the case if the first linkage were straight. Two contact points result in a more stable configuration of the drop-down drawer mechanism 22, since the weight of the carrier 200 and any contents thereof is more evenly distributed across the linkages 202, 205 rather than all of the weight being concentrated at one point.

Although in the illustrated example the two linkages 202, 205 are arranged on the same horizontal level (i.e. the first ends 203, 206 of the linkages 202, 205 are on the same horizontal level, and the second ends 204, 207 of the linkages are on the same horizontal level except when the linkages drop below horizontal), in other examples the linkages may be positioned differently. For example, the first ends of the linkages may be vertically offset, i.e. the first end of the first linkage can be positioned at a lower vertical level than the first end of the second linkage. Of course, other arrangements are possible. In some examples, it may not be necessary for one of the linkages to be shaped so that the two linkages do not obstruct one another as the carrier 200 drops down and tilts forwards.

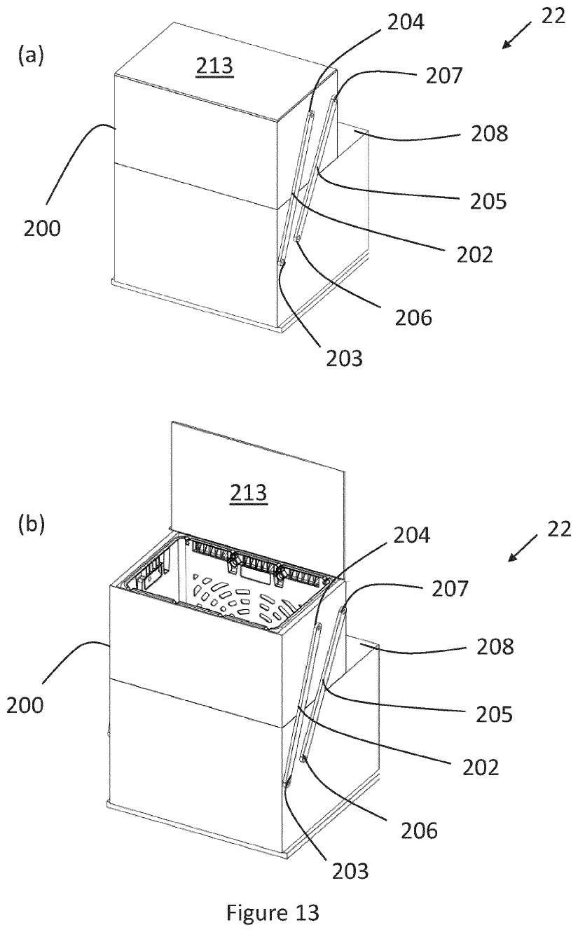

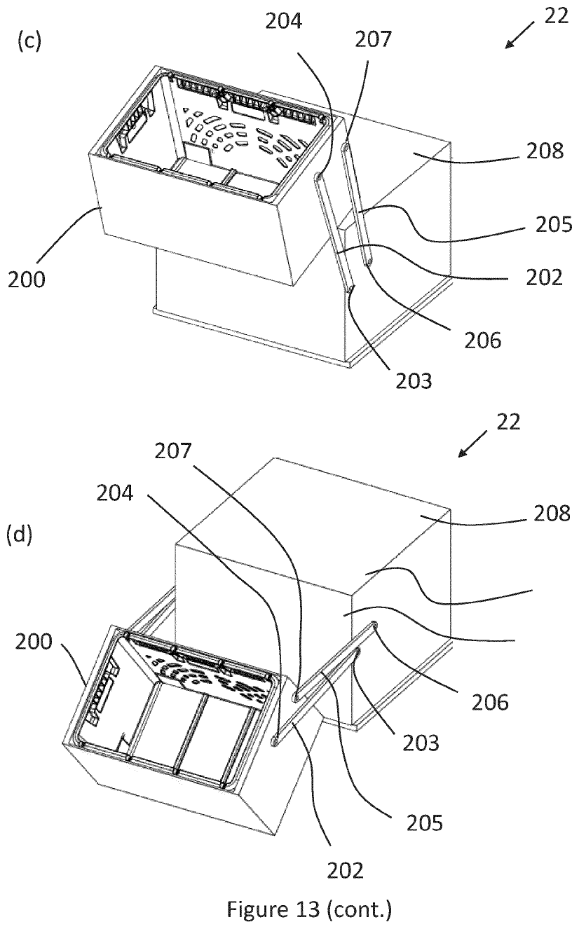

FIG. 13 (a to d) illustrates an example where both linkages 202, 205 are straight, and the tilting is achieved by vertically offsetting the linkages. The first end 203 of the first linkage 202 is fixed at a lower vertical level than the first end 206 of the second linkage 205. Unlike the implementation shown in FIGS. 10, 11, and 12, in the example of FIG. 13 the carrier 200 tilts as it drops down, rather than remaining horizontal until the carrier 200 has moved as far down as it can, and then tilting downwards into the deployed position. The lower level of the first end 203 of the first linkage 202 permits the two linkages 202, 205 to pivot down beyond the horizontal and to tilt the carrier 200.

In FIG. 13(a), the carrier 200 is illustrated in the stowed position with a lid 213 closing the top of the carrier 200. This provides an additional layer of security. The lid 213 may be provided as part of an outer shell 201 (not shown). The lid 213 must be opened in order to move the carrier 200 into the deployed position. FIG. 13(b) illustrates the carrier 200 in the stowed position with the lid 213 open. FIG. 13(c) illustrates the carrier 200 in an intermediate position between the stowed position and the deployed position. It can be seen that the carrier 200 is tilted forwards slightly. FIG. 13(d) illustrates the carrier 200 in the deployed position. The first linkage 202 has rotated slightly below the horizontal, and the second linkage 205 has rotated to just above the horizontal. Further rotation of the linkages is prevented because the second linkage 205 is resting on the second end 203 of the first linkage 202, and is thus prevented from rotating farther. The carrier 200 is tilted forwards.

The lid 213 at the top of the carrier 200 effectively decouples the presentation of the goods/items within the carrier 200 and the security of the carrier 200. The lid 213 provides security for the drop-down drawer mechanism 22, both in preventing unauthorized access to the contents of the carrier 200 when in the stowed position, and in preventing the carrier 200 from being moved from the stowed position to the deployed position. The path of the carrier 200 between the stowed position and the deployed position is such that the carrier 200 initially moves vertically upwards as the carrier 200 moves out of the outer shell 201, so the presence of a closed lid 213 will prevent the carrier 200 from moving to its deployed position. The lid 213 allows more effective use of storage space within the vehicle, because there is no need to provide sufficient headroom to allow the tilting drawer mechanism 12 to start to deploy when the wing door 40 is closed; since the lid 213 provides security for the individual storage devices, there is no risk of unauthorized access to other storage devices that remain in the stowed position.

The linkage arrangements shown in the figures are examples only, and other combinations of curved, angled, or straight linkages are possible, including linkages that are vertically offset at their first ends, their second ends, or both. In general, the length and shape of the first and second linkages 202, 205, along with the positions of the first ends 203, 206 and the second ends 204, 207, can be varied in order to define the path that the carrier takes between the stowed position and the deployed position.

In a similar manner to the tilting drawer mechanism 12 as described above, the movement of the drop-down drawer mechanism 22 can be automated. For example, the first and/or second linkages 202, 205 can be driven by a motor on the first end 203, 207 of the linkage 202, 205. In some cases a gearbox can be used to reduce the speed of the motor. Alternatively, the drop-down drawer mechanism 22 can comprise an actuating arm configured to drive the carrier 200 between the stowed position and the deployed position. The length of the actuating arm can be varied using a leadscrew. Alternatively, one or more linear motors can be used to push/pull the first and/or second linkages 202, 205 and/or the carrier 200. Gas struts (gas pressure dampers) can be used to bear some of the weight of the carrier 200 and any goods therein, so that the motor(s) are subject to lower forces so can be of a lower specification and therefore less expensive. Alternatively, actuation can be provided by a large gear wheel driven by a pinion, driven by one or more motors. Any combination of these or other appropriate actuation mechanisms can be used.

### Other Arrangements of Storage Devices

In the example illustrated in FIGS. 1 to 3, the vehicle 1 has four first-type storage devices 12 in the first row 11, and four second-type storage devices 22 in the second row 21. The number of first-type storage devices 12 in the first row 11 is equal to the number of second-type storage devices 22 in the second row 21, and the first-type storage devices 12 and the second-type storage devices 22 are arranged such that each second-type storage device 22 in the second row 21 is vertically above a respective first-type storage device 12 in the first row 11. The first-type storage devices 12 and the second-type storage devices 22 are of equal size. In other examples, there may be different numbers and/or sizes of first-type storage devices 12 and second-type storage devices.

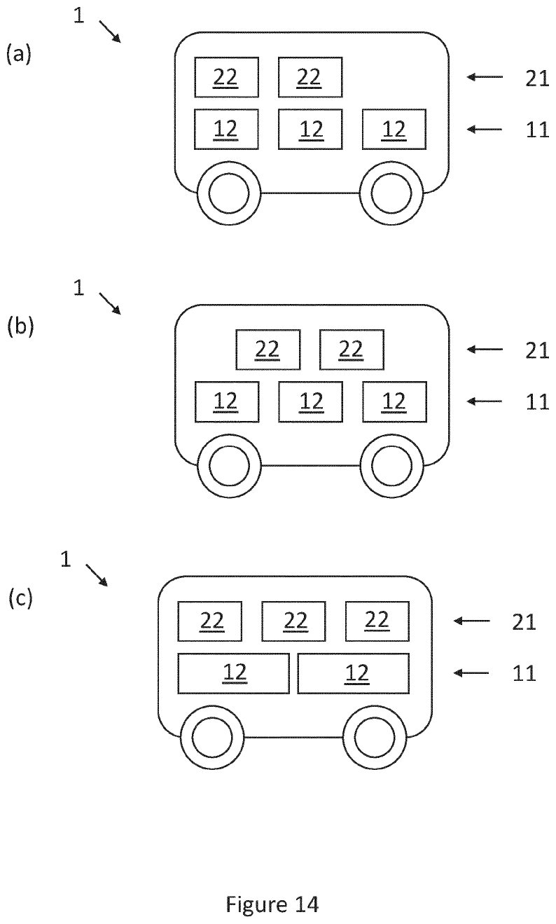

FIG. 14(a to c) illustrates some other possible arrangements of storage devices on a vehicle. In FIG. 14(a), the first row 11 comprises a greater number of first-type storage devices 12 than the second row 21 comprises second-type storage devices 22. In FIG. 14(b), the second-type storage devices 22 in the second row 21 are horizontally offset relative to the first-type storage devices 12 in the first row 11, so each second-type storage device 22 is not directly above a single first-type storage device 12. In FIG. 14(c), the first-type storage devices 12 in the first row 11 are larger and less numerous than the second-type storage devices 22 in the second row 21. Arrangements with different sizes of storage devices may be useful in situations where the size of orders varies significantly, i.e. smaller storage device scan be used for smaller orders of single items or small numbers of items, and larger storage devices can be used for larger orders, e.g. grocery orders, or orders containing larger items.

In some examples the first row of one or more first-type storage devices comprises two first rows arranged on opposite sides of the vehicle, and the second row of one or more second-type storage devices comprises two second rows arranged on opposite sides of the vehicle.

In some examples, the first and second rows could be arranged at the front and/or at the back of the vehicle, as an alternative to being arranged at the sides of the vehicle, or in addition to rows arranged at the sides of the vehicle. In cases where the vehicle is an autonomous vehicle, there is no driver and no passengers so no need for “crumple zones” at the front and rear of the vehicle. This permits the use of the front and rear for further storage. In some examples the vehicle does not have a defined front end and rear end, and can be driven in either direction. In some examples the wheels of the vehicle can change direction, so the vehicle can drive in any direction rather than just forwards or backwards. In these examples there is more design freedom and the possibility to make better use of storage space on the vehicle by placing rows of storage devices on any or all sides of the vehicle.

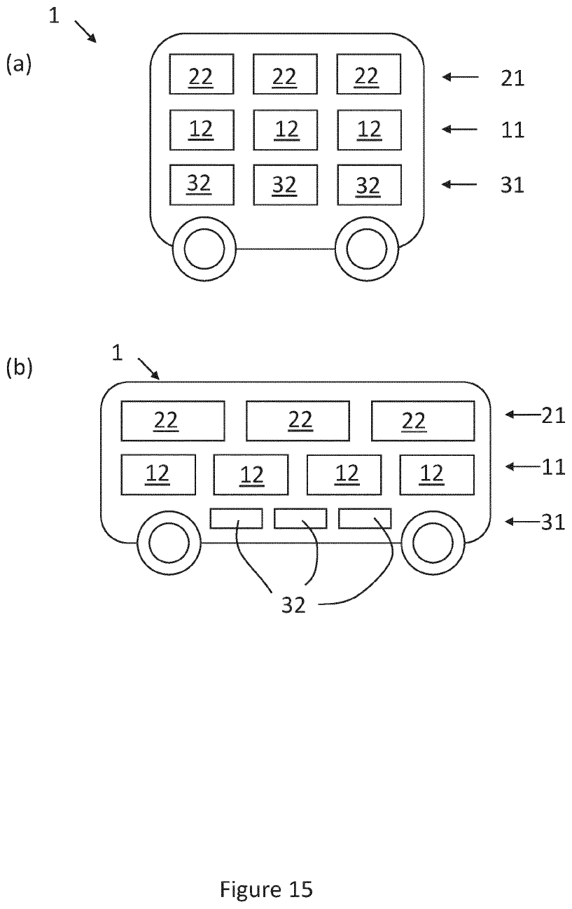

In some examples, the vehicle may be provided with more than two rows of storage devices, as illustrated in FIG. 15 (a and b). For example the vehicle may further comprise a third row 31 of third-type storage devices 32 located vertically below the first row 11 of first-type storage devices 12. The third-type storage devices 32 may be the same as the first-type 12 and/or second-type storage devices 22, or may be a different type of storage device. The number of third-type storage devices 32 in the third row 31 can be equal to the number of first-type storage devices 12 in the first row 11 and/or the number of second-type storage devices 22 in the second row 21, or a different number. Each third-type storage device 32 in the third row 31 can be vertically below a respective first-type storage device 12 in the first row 11, or horizontally offset relative to the first-type storage devices 12.

In FIG. 15(a), the number of third-type storage devices 32 in the third row 31 is equal to the number of first-type storage devices 12 in the first row 12 and equal to the number of second-type storage devices 22 in the second row 21. The storage devices are aligned so that each third-type storage device 32 in the third row 31 is vertically below a respective first-type storage device 12 in the first row 11, and each first-type storage device 12 in the first row 11 is vertically below a respective second-type storage device 22 in the second row 21.

In FIG. 15(b), the third-type storage devices 32 in the third row 31 are located within the wheelbase of the vehicle 1, i.e. in the space between the front wheels and the rear wheels of the vehicle 1. This arrangement is advantageous because it makes effective use of the available space within the vehicle 1.

In some examples the spatial volume occupied by a third carrier of one of the third-type storage devices 33 when in a third deployed position occupies at least a portion of the spatial volume occupied by the first carrier of one of the first-type storage devices 12 when in the first deployed position. For example, the third-type storage devices could be configured to move outwards and upwards, so that the third deployed position is at a higher vertical level than the third stowed position.

In other examples, the vehicle may be provided with further rows of storage devices, for example a fourth row. The vehicle can have any number of rows of storage devices, each row with any number of storage devices, depending on the size and shape of the vehicle and the size and shape of the storage devices.

### Vehicle Access

In some of the examples illustrated above, the first-type storage devices 12 comprise an outer shell 124, which receives the first carrier when the first carrier is in the first stowed position. Similarly, in some of the illustrated examples the second-type storage devices 22 comprise an outer shell 201, which receives the second carrier 200 when the second carrier 200 is in the second stowed position.

Although in the illustrated examples each storage device has a respective outer shell (i.e. each first-type storage device 12 comprises one outer shell 124 and each second-type storage device 22 comprises one outer shell 201), in other examples multiple storage devices could be received within the same outer shell.

In some examples, the outer shell of one or more of the first-type storage devices and/or the second-type storage devices can comprise a door configured to prevent access to the carrier when the carrier is in the stowed position received within the outer shell. When access to the carrier is required, the door can be opened in order to allow the carrier to move into the deployed position so that goods/items can be retrieved from the carrier. For example, the lid 213 illustrated in FIG. 13 in relation to the tilting drawer mechanism 22 is a type of door, and can be provided as part of the outer shell 201.

In some examples the door can comprise a locking mechanism, in order to prevent or permit access to individual storage devices on the vehicle. Advantageously, a locking mechanism ensures that only authorized access is possible. For example, a customer may be provided with a physical key or a key code to unlock the door(s) of the storage devices containing their order, so the customer can access the storage devices containing their own order but not any other storage devices.

In more sophisticated systems, the vehicle may further comprise a control system configured to selectively operate the locking mechanism to allow one or more doors to be opened in order to provide access to one or more of the first-type storage devices and/or the second-type storage devices. For example, an access code could be sent to a customer's mobile device, which the customer then inputs in order to retrieve their order. Upon receiving the correct access code, the control system would instruct the locking mechanism to unlock the appropriate door to enable the customer to access their goods from the appropriate storage device.

In some examples the vehicle can be provided with a display to provide information about customer orders (for example, a list of all products in the order, the customer name, whether any goods were out of stock and needed to be substituted). In some examples the display can comprise a graphical user interface to enable the customer to interact with the storage system to retrieve their order from one or more lockers, for example by entering an access code. The graphical user interface may include one or more input devices, for example a keyboard or mouse or trackpad or touchscreen where the customer can make selections.

In some examples sensors can be used to detect information about the customer. For example, a proximity sensor could be used to detect when a customer approaches the vehicle, and the graphical user interface could react by displaying a welcome message. One or more cameras could be mounted on the vehicle along with the display. The one or more cameras could be used to identify a customer using facial recognition technology. The display can then show a personalized welcome message for that customer. Information specifically tailored to that customer can be displayed, for example special offers or product recommendations.

Facial recognition technology could also be used to identify the customer and open the door(s) of the storage device(s) containing the customer's order. For example, the one or more cameras could be used to identify a customer and the control system would instruct the locking mechanism to only open the door of the storage device(s) containing that customer's order. If the facial recognition technology does not recognize the person approaching the vehicle, the control system ensures that the locking mechanism is activated so that the doors remain locked.

When the customer has retrieved their goods from the storage device, or when a customer stops interacting with the graphical user interface, the control system may be configured to close the door of the storage device(s) automatically, then activate the locking mechanism to lock the door. One or more cameras or proximity sensors can be used to determine whether the customer has walked away from the vehicle, even if the customer has not collected their goods. Once the interaction is over (whether completed or abandoned), the control system can instruct the doors to close and lock in order to prevent access to the goods in the storage devices.

In some examples, such as those illustrated in FIGS. 1 to 3, the storage devices in the vehicle 1 are enclosed by a vehicle shell 41. The vehicle shell 41 encloses the storage devices in order to prevent unauthorized access and provide an additional layer of security. In some cases the outer shells of the storage devices can be enclosed by the vehicle shell, but in other cases one or more of the outer shells of the storage devices can form part of the vehicle shell. One or more vehicle doors 40 can be used to permit access to the storage devices in the interior of the vehicle.

In the example illustrated in FIGS. 1 to 3 the vehicle shell 41 has a pair of vehicle doors 40 configured to allow access to the first-type storage devices 12 and the second-type storage devices 22 to allow retrieval of orders from the vehicle 1. In the example illustrated, the vehicle doors 40 are a pair of wing doors, with a separate wing door on each side of the vehicle 1. In other examples the vehicle 1 may be provided with a single door, or a larger number of doors. In the illustrated example, the vehicle doors 41 are used for both loading/unloading goods onto the vehicle 1, and for retrieving orders from the first-type storage devices 12 and the second-type storage devices 22.

The vehicle 1 is effectively a double-sided storage system where storage devices are accessible from opposite sides of the vehicle 1. A first row 11 of first-type storage devices 12 and a second row 21 of second-type storage devices 22 is accessible from one side of the vehicle 1, and a further first row 11 of first-type storage devices 12 and a further second row 21 of second-type storage devices 22 is accessible from the opposite side of the vehicle 1. An advantage of storage devices 12, 22 being accessible from two sides of the vehicle 1 is that storage devices on both sides of the vehicle can be accessed at the same time. This is useful in examples where the vehicle has a high throughput of orders, or where individual orders are large and occupy several storage devices 12, 22. Another advantage of first-type 12 and second-type storage devices 22 being accessible from two sides is that the vehicle 1 can park on either side of the road to allow retrieval of orders. If the control system knows in advance which side of the vehicle contains a specific order, the vehicle can park in such a way that the storage device(s) containing the appropriate order are next to the pavement, in order to facilitate easy retrieval.

The vehicle 1 comprises a vehicle chassis, comprising wheels driven by a drivetrain powered by, for example, an internal combustion engine and/or an electric motor, in order to enable the vehicle to move. The vehicle shell 41 may be configured to be removably mounted on the vehicle chassis, or the vehicle shell 41 may be integral with the vehicle chassis. The vehicle shell 41 comprises side walls and a top wall, and the vehicle doors 40. When closed, the vehicle doors 40 form part of the vehicle shell.

The vehicle can be used to transport items from a warehouse or fulfilment center to a location where individual orders can be collected (i.e. a “click and collect” system), and/or the vehicle can be used for delivery of orders to a plurality of different delivery addresses.

In some examples, the vehicle can be an autonomous vehicle. The autonomous vehicle may comprise one or more sensors (e.g. cameras, radar, lidar, sonar, GPS, etc.) and a control system configured to receive input from the one or more sensors to allow the vehicle to drive between a plurality of destinations without input, or with minimal input, from a human driver. The control system may be configured to control one or more of: speed, steering, and braking of the vehicle.

1. A vehicle comprising:
a first row of one or more first-type storage devices, each first-type storage device comprising a first carrier configured to be moved outwards from a first stowed position to a first deployed position substantially outside a footprint of the vehicle; and
a second row of one or more second-type storage devices located vertically above the first row of first-type storage devices, wherein each of the one or more second-type storage devices comprises a second carrier configured to be moved outwards from a second stowed position to a second deployed position substantially outside the footprint of the vehicle;
wherein a spatial volume occupied by one of the second carriers when in the second deployed position occupies at least a portion of the spatial volume occupied by one of the first carriers when in the first deployed position.

2. The vehicle of claim 1, wherein one or more of the first carriers is configured to move from the first stowed position to the first deployed position by sliding in a substantially horizontal direction and tilting such that the first carrier is rotated relative to the horizontal in the first deployed position.

3. The vehicle of claim 2, wherein the first-type storage device further comprises a guide configured to constrain the first carrier to move between the first stowed position and the first deployed position.

4. The vehicle of claim 3, wherein the first carrier further comprises a traveler configured to travel along the guide in order to guide the movement of the first carrier between the first stowed position and the first deployed position, and the guide comprises a substantially horizontal portion configured to guide the traveler of the first carrier in a substantially horizontal direction, and an upturned portion configured to guide the traveler of the first carrier in an upwards direction such that the first carrier tilts downwards in the deployed position.

5. The vehicle of claim 4, wherein the first carrier further comprises a runner configured to be supported by two or more bearings as the traveler moves along the substantially horizontal portion of the guide in a substantially horizontal direction, and wherein the runner of the first carrier is configured to pivot on one of the two or more bearings as the traveler moves along the upturned portion of the guide and the first carrier tilts downwards.

6. (canceled)

7. The vehicle of claim 5, wherein the guide further comprises a downturned portion configured to guide the traveler of the first carrier in a downwards direction such that the first carrier tilts farther downwards.

8. The vehicle of claim 3, wherein the guide comprises:
a first elongated part secured to the vehicle; and
a second elongated part slidingly engageable with the first elongated part such that the second elongated part is configured to slide horizontally with respect to the first elongated part, the second elongated part being pivotably attached to the outside of the first carrier;
such that the first carrier is configured to rotate relative to the second elongated part.

9. The vehicle of claim 8, wherein the first-type storage device further comprises an outer shell configured to receive the first carrier, such that in the first stowed position the first carrier is received within the outer shell, and in the first deployed position the first carrier is substantially outside the outer shell, and the first elongated part is secured to the inside of the outer shell, wherein the outer shell limits rotation of the first carrier relative to the outer shell when the first carrier is in the first stowed position, and permits rotation of the first carrier relative to the outer shell when the first carrier is in the first deployed position.

10. The vehicle of claim 3, wherein the first-type storage device further comprises a chain connected at a first end to the first carrier, such that pulling the chain at a second end moves the first carrier from the first deployed position to the first stowed position.

11. The vehicle of claim 10, wherein the chain is constrained via a chain guide, such that the chain is sufficiently rigid so that pushing the chain at the second end moves the first carrier from the first stowed position to the first deployed position.

12. The vehicle of claim 11, wherein the guide comprises the chain guide.

13. The vehicle of claim 1, wherein at least one of the second carriers is configured to move from the second stowed position to the second deployed position, wherein the second deployed position is at a lower vertical level than the second stowed position, and wherein the second carrier is further configured to tilt such that the second carrier is rotated relative to the horizontal in the second deployed position.

14. (canceled)

15. The vehicle of claim 13, wherein the second-type storage device comprises:
a first linkage, pivotably connected at a first end to a first fixed point on the vehicle and pivotally connected at a second end to the second carrier; and
a second linkage, pivotably connected at a first end to a second fixed point on the vehicle and pivotally connected at a second end to the second carrier;
such that the second carrier is configured to follow a curved path from the second stowed position to the second deployed position.

16. The vehicle of claim 15, wherein when the second carrier is in the second deployed position, the second end of the first linkage is at a lower vertical level than the first end of the first linkage.

17. The vehicle of claim 13, wherein when the second carrier is in the second deployed position, the second end of the second linkage is at a lower vertical level than the first end of the second linkage.

18. The vehicle of claim 17, wherein the second linkage is shaped such that the first and second linkages are able to pivot below the horizontal to lower the second carrier to the second deployed position without the first linkage obstructing the second linkage.

19. (canceled)

20. The vehicle of claim 18, wherein the first linkage is shaped such that, when the second carrier is in the deployed position, the second linkage rests on the first linkage at two contact points between the first linkage and the second linkage.

21. The vehicle of claim 15, wherein the first fixed point is at a lower vertical level than the second fixed point, such that the first linkage is prevented from obstructing the second linkage in order to permit the first and second linkages to lower the second carrier to the second deployed position.

22. (canceled)

23. The vehicle of claim 1, further comprising a third row of third-type storage devices located vertically below the first row of first-type storage devices, wherein each of the one or more third-type storage devices comprises a third carrier configured to be moved outwards from a third stowed position to a third deployed position substantially outside the footprint of the vehicle.

24. The vehicle of claim 23, wherein the spatial volume occupied by one of the third carriers when in the third deployed position occupies at least a portion of the spatial volume occupied by one of the first carriers when in the first deployed position.
